(19) United States
(12) Patent Application Publication
(10) Pub. No.: US 2001/0052053 A1
(43) Pub. Date: Dec. 13, 2001

(54) Stream processing unit for a multi-streaming processor

(76) Inventors: Mario Nemirovsky, Saratoga, CA (US); Stephen Melvin, San Francisco, CA (US)

Correspondence Address: CENTRAL COAST PATENT AGENCY, PO BOX 187, AROMAS, CA, 95004, US

(21) Appl. No.: 09/826,693

(22) Filed: Apr. 4, 2001

Related U.S. Application Data
(63) Continuation-in-part of application No. 09/737,375, filed on Dec. 14, 2000.
(60) Provisional application No. 60/181,364, filed on Feb. 8, 2000.

(51) Int. Cl. G06F 12/08

(52) U.S. Cl. 711/138; 711/126; 711/125

(57) ABSTRACT

A bypass system for a data cache has two ports to the data cache, registers for multiple data entries, a bus connection for accepting read and write operations to the cache, and address matching and switching logic. The system is characterized in that write operations that hit in the data cache are stored as elements in the bypass structure before the data is written to the data cache, and read operations use the address matching logic to search the elements of the bypass structure to identify and use any one or more of the entries representing data more recent than that stored in the data cache memory array, such that a subsequent write operation may free a memory port for a write stored in the bypass structure to be written to the data cache memory array. In a preferred embodiment there are six entries in the bypass system, and stalls are eliminated.

### CROSS-REFERENCE TO RELATED DOCUMENTS

The present application is related as a continuation in part (CIP) to a copending patent application entitled “Queueing System for Processors in Packet Routing Operations” filed Dec. 14, 2000, and bearing Ser. No. 09/737,375, which claims priority to Provisional patent application 60/181,364 filed on Feb. 8, 2000, and incorporates all disclosure of both prior applications by reference.

### FIELD OF THE INVENTION

The present invention is in the field of digital processing and pertains to apparatus and methods for processing packets in routers for packet networks, and more particularly to apparatus and methods for stream processing functions, especially in dynamic Multi-streaming processors dedicated to such routers.

### BACKGROUND OF THE INVENTION

The well-known Internet network is a notoriously well-known publicly-accessible communication network at the time of filing the present patent application, and arguably the most robust information and communication source ever made available. The Internet is used as a prime example in the present application of a data-packet-network which will benefit from the apparatus and methods taught in the present patent application, but is just one such network, following a particular standardized protocol. As is also very well known, the Internet (and related networks) are always a work in progress. That is, many researchers and developers are competing at all times to provide new and better apparatus and methods, including software, for enhancing the operation of such networks.

In general the most sought-after improvements in data packet networks are those that provide higher speed in routing (more packets per unit time) and better reliability and fidelity in messaging. What is generally needed are router apparatus and methods increasing the rates at which packets may be processed in a router.

As is well-known in the art, packet routers are computerized machines wherein data packets are received at any one or more of typically multiple ports, processed in some fashion, and sent out at the same or other ports of the router to continue on to downstream destinations. As an example of such computerized operations, keeping in mind that the Internet is a vast interconnected network of individual routers, individual routers have to keep track of which external routers to which they are connected by communication ports, and of which of alternate routes through the network are the best routes for incoming packets. Individual routers must also accomplish flow accounting, with a flow generally meaning a stream of packets with a common source and end destination. A general desire is that individual flows follow a common path. The skilled artisan will be aware of many such requirements for computerized processing.

Typically a router in the Internet network will have one or more Central Processing Units (CPUs) as dedicated microprocessors for accomplishing the many computing tasks required. In the current art at the time of the present application, these are single-streaming processors; that is, each processor is capable of processing a single stream of instructions. In some cases developers are applying multiprocessor technology to such routing operations. The present inventors have been involved for some time in development of dynamic Multi-streaming (DMS) processors, which processors are capable of simultaneously processing multiple instruction streams. One preferred application for such processors is in the processing of packets in packet networks like the Internet.

In the provisional patent application listed in the Cross-Reference to Related Documents above there are descriptions and drawings for a preferred architecture for DMS application to packet processing. Among the functional areas in that architecture is a Stream Processing Unit (SPU) and related methods and circuitry. It to this SPU system, described in enabling detail below, that the present patent application generally pertains.

### SUMMARY OF THE INVENTION

In a preferred embodiment of the present invention a bypass system for a data cache is provided, comprising two ports to the data cache, registers for multiple data entries, a bus connection for accepting read and write operations to the cache, and address matching and switching logic. The system is characterized in that write operations that hit in the data cache are stored as elements in the bypass structure before the data is written to the data cache, and read operations use the address matching logic to search the elements of the bypass structure to identify and use any one or more of the entries representing data more recent than that stored in the data cache memory array, such that a subsequent write operation may free a memory port for a write stored in the bypass structure to be written to the data cache memory array.

In preferred embodiments the memory operations are limited to 32 bits, and there are six distinct entries in the bypass system, which is enough to ensure that stalls will not occur.

In an alternative embodiment a data cache system is provided, comprising a data cache memory array, and a bypass system connected to the data cache memory array by two ports, and to a bus for accepting read and write operations to the system, and having address matching and switching logic. This system is characterized in that write operations that hit in the data cache are stored as elements in the bypass structure before the data is written to the data cache, and read operations use the address matching logic to search the elements of the bypass structure to identify and use any one or more of the entries representing data more recent than that stored in the data cache memory array, such that a subsequent write operation may free a memory port for a write stored in the bypass structure to be written to the data cache memory array.

In some embodiments of the system the memory operations are limited to 32 bits, and there are six distinct entries in the bypass system.

In yet another aspect a method for eliminating stalls in read and write operations to a data cache is provided, comprising steps of (a) implementing a bypass system having multiple entries and switching and address matching logic, connected to the data cache memory array by two ports and to a bus for accepting read and write operations; (b) storing write operations that hit in the cache as entries in the bypass structure before associated data is written to the cache; (c) searching the bypass structure entries by read operations, using the address matching and switching logic to determine if entries in the bypass structure represent newer data than that available in the data cache memory array; and (d) using the opportunity of a subsequent write operation to free a memory port for simultaneously writing from the bypass structure to the memory array. In a preferred embodiment memory operations are limited to 32 bits, and there are six distinct entries in the bypass system.

In various embodiments of the invention taught in enabling detail below, for the first time a data cache bypass system is provided that eliminates stalls in cache operations.

### BRIEF DESCRIPTION OF THE DRAWING FIGURES

FIG. 1 is a block diagram of a stream processing unit in an embodiment of the present invention.

FIG. 2 is a table illustrating updates that are made to least-recently-used (LRU) bits in an embodiment of the invention.

FIG. 3 is a diagram illustrating dispatching of instructions from instruction queues to function units in an embodiment of the present invention.

FIG. 4 is a pipeline timing diagram in an embodiment of the invention.

FIG. 5 is an illustration of a masked load/store instruction in an embodiment of the invention.

FIG. 6 is an illustration of LDX/STX registers in an embodiment of the invention.

FIG. 7 is an illustration of special arithmetic instructions in an embodiment of the present invention.

FIG. 8 is an illustration of a Siesta instruction in an embodiment of the invention.

FIG. 9 is an illustration of packet memory instructions in an embodiment of the present invention.

FIG. 10 is an illustration of queing system instructions in an embodiment of the present invention.

FIG. 11 is an illustration of RTU instructions in an embodiment of the invention.

FIG. 12 is a flow diagram depicting operation of interrupts in an embodiment of the invention.

FIG. 13 is an illustration of an extended interrupt mask register in an embodiment of the invention.

FIG. 14 is an illustration of an extended interrupt pending register in an embodiment of the invention.

FIG. 15 is an illustration of a context register in an embodiment of the invention.

FIG. 16 illustrates a PMU/SPU interface in an embodiment of the present invention.

FIG. 17 illustrates an SIU/SPU Interface in an embodiment of the invention.

FIG. 18 illustrates a Global Extended Interrupt Pending (GXIP) register, used to store interrupt pending bits for each of the PMU and thread interrupts.

FIG. 19 is a diagram of the communication interface between the SPU and the PMU.

FIG. 20 is a diagram of the SIU to SPU Interface.

FIG. 21 is an illustration of the performance counter interface between the SPU and the SIU.

FIG. 22 illustrates the OCI interface between the SIU and the SPU.

FIG. 23 shows the vectors utilized by the XCaliber processor.

FIG. 24 is a table presenting the list of exceptions and their cause codes.

FIG. 25 illustrates a Context Number Register.

FIG. 26 shows a Config Register.

The Table presented as

FIG. 27 illustrates the detailed behavior of the OCI with respect to the OCI logic and the SPU.

FIG. 28 is a table relating three type bits to Type.

### DESCRIPTION OF THE PREFERRED EMBODIMENTS

Overviews

In the copending priority documents Ser. Nos. 09/737,375 and 60/181,364 referenced above, overall structure of a dynamic Multi-streaming processor particularly adapted to packet routing in packet networks, such as the well-known Internet network is described, including architectural reference to a part of the processor known as a Stream Processing Unit (SPU). The processor described as a primary example in the priority document is known to the inventors as the XCaliber processor, and the SPU portion of that processor is that portion devoted in general to actual processing of packets, as opposed to packet management functions performed by other portions of the XCaliber processor described in the priority document.

The SPU block within the XCaliber processor is the dynamic multi-streaming (DMS) microprocessor core. The SPU fetches and executes all instructions, handles interrupts and exceptions and communicates with the Packet Management Unit (PMU) previously described through commands and memory mapped registers. There are in a preferred embodiment eight streams running within the SPU at any time, and each stream may issue up to four instructions every cycle. There are in the same preferred embodiment eight function units and two ports to memory, and therefore a maximum of ten instructions may be issued from all active streams in each cycle of the processor.

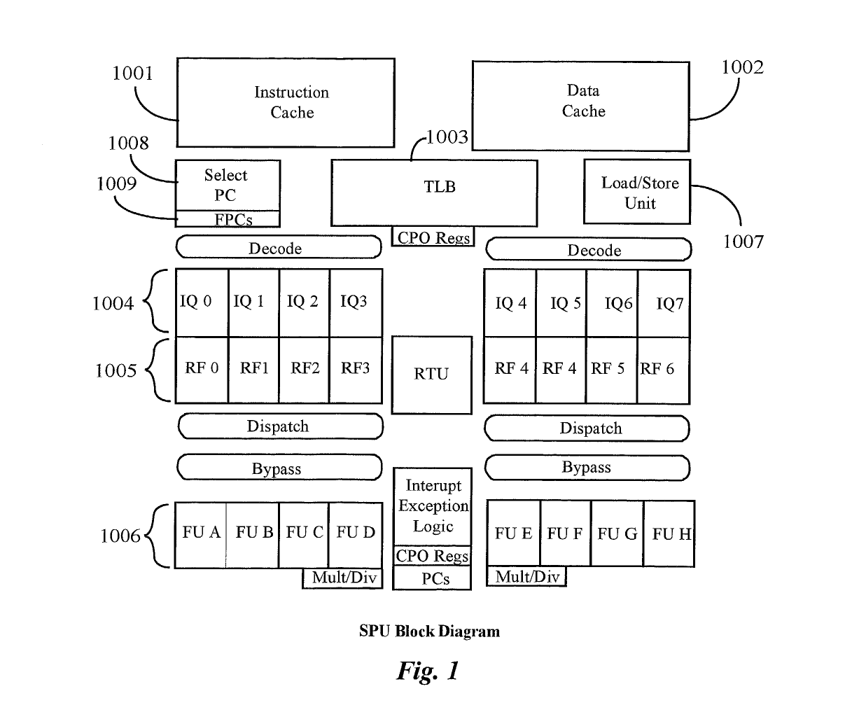

FIG. 1 is a block diagram of the SPU. The major blocks in the SPU consist of Instruction and Data Caches 1001 and 1002 respectively, a Translation Lookaside Buffer (TLB), Instruction Queues (IQ) 1004, one for each stream, Register Files (RF) 1005, also one for each stream, eight Function Units (FU) (1006), labeled FU A through FU H, and a Load/Store Unit 1007. Each of these elements is described in further detail below. The pipeline of the SPU is described below as well, with a detailed description of what occurs in each stage of the pipeline.

The SPU in the XCaliber processor is based on the well-known MIPS instruction set architecture and implements most of the 32-bit MIPS-IV instruction set with the exception of floating point instructions. User-mode binaries are able to be run without modification in most circumstances with floating point emulation support in software. Additional instructions have been added to the MIPS instruction set to support communication with the PMU, communication between threads, as well as other features.

An overview of each element of the SPU now follows, and further detail including inter-operational details is provided later in this specification.

Instruction Cache Overview

The instruction cache in the SPU is 64K bytes in size and its organization is 4-way set associative with a 64-byte line size. The cache is dual ported, so instructions for up to two streams may be fetched in each cycle. Each port can fetch up to 32 bytes of instruction data (8 instructions). The instruction data which is fetched is 16-byte aligned, and one of four possible fetch patterns is possible, These are bytes 0-31, bytes 16-47, bytes 32-63 and bytes 48-63, depending on target program counter (PC) being fetched. The mechanism by which a PC is selected is described in additional detail below.

Thus the instruction cache supplies 8 instructions from each port, except in the case that the target PC is in the last four instructions of the 16-instruction line, in which case only 4 instructions will be supplied. This arrangement translates to an average number of valid instructions returned equal to 5.5 instructions given a random target PC. In the worst case only one valid instruction will be returned (if the target PC points to the last instruction in an aligned 16-instruction block). For straight line code, the fetch PC will be aligned to the next 4-instruction boundary after the instructions previously fetched.

Physically the instruction cache is organized into 16 banks, each of which is 16 bytes wide. Four banks make up one 64-byte line and there are four ways. There is no parity or ECC in the instruction cache. The instruction cache consists of 256 sets. The eight-bit set index comes from bits 6-13 of the physical address. Address translation occurs in a Select stage previous to instruction cache accessing, thus the physical address of the PC being fetched is always available. Pipeline timing is explained in more detail in the next section.

In addition to the 16 banks in the Instruction Cache described above, the instruction cache also includes four banks containing tags and an LRU (least recently used) structure. The tag array contains bits 14-35 of the physical address (22 bits). There is a also a validity (valid) bit associated with each line. During a fetch from the instruction cache all four ways are accessed for two of the four banks that make up a cache line (depending on the target fetch address as explained above). Simultaneously the tags for all four ways are accessed. The result of comparing all four tags with the physical address from the TLB is used to select one of the four ways read.

The instruction cache implements a true least recently used (LRU) replacement in which there are six bits for each set and when an access occurs, three of the six bits for the appropriate set are modified and three bits are not modified. In an alternative preferred embodiment a random replacement scheme and method is used. The previous state of the bits does not have to be read, an LRU update consists only of writing data to the LRU array. In the case that the two accesses on the two read ports both access the same set, the LRU bits are updated to reflect that up to two ways are most recently used. In each cycle the LRU data structure can handle writes of two different entries, and can write selected bits in each entry being written.

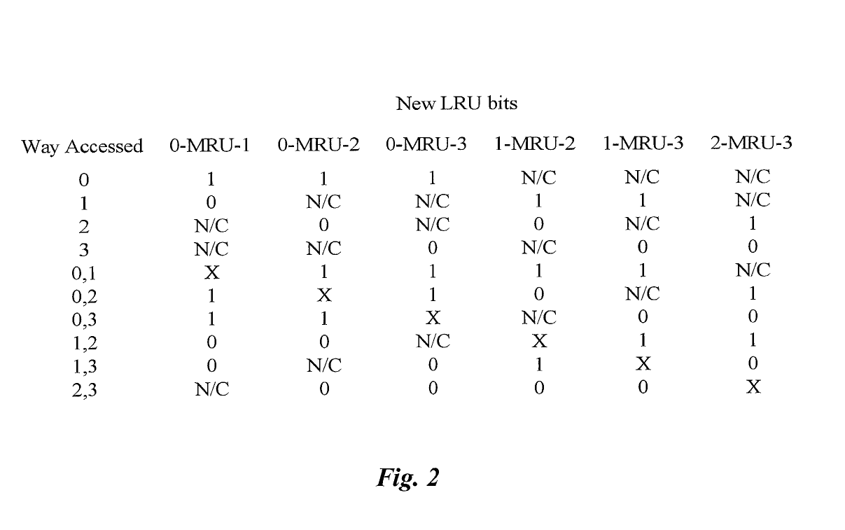

FIG. 2 is a table illustrating the updates to the that are made. The entries indicated with “N/C” are not changed from their previous contents. The entries marked with an X are don't cares and may be updated to either or 0 or a 1, or they may be left the same.

The replacement set is chosen just before data is written. Instruction cache miss data comes from the System Interface Unit (SIU), 16-bytes at a time, and it is buffered into a full 64-bytes before being written. In the cycle that the last 16-byte block is being received, the LRU data structure is accessed to determine which way should be overwritten. The following logic illustrates how the LRU determination is made:

if (not 0-MRU-1 AND not 0-MRU-2 AND not 0-MRU-3) LRU way is 0

else if (0-MRU-1 AND not 1-MRU-2 AND not 1-MRU-3) LRU way is 1

else if (0-MRU-2 AND 1-MRU-2 AND not 2-MRU-3) LRU way is 2

else if (0-MRU-3 AND -NMRU-3 AND 2-MRU-3) LRU way 3

else (don't care, can't happen)

The data in the instruction cache can never be modified, so there are no dirty bits and no need to write back data on a replacement. When data from the SIU is being written into the Instruction Cache, one of the two ports is used by the write, so only one fetch can take place from the two ports in that cycle. However, bypass logic allows the data to be used in the same cycle as it is written. If there is at least one stream waiting for an instruction in the line being written, stream selection logic and bypass logic will guarantee that at least one stream gets its data from the bypass path. This allows forward progress to be made even if the line being replaced is replaced itself before it can be read. In the special case that the instruction data being returned by the SIU is not cacheable, then only this bypass path is enabled, and the write to the instruction cache does not take place. In the case that no stream is waiting for SIU return data the data is written to the instruction cache (if cacheable), but the instructions is not utilized by the fetch stage. This situation can occur if an instruction cache miss is generated followed by an interrupt or exception that changes the fetch PC of the associated instruction stream.

Translation Lookaside Buffer Overview

The XCaliber processor incorporates a fully associative TLB similar to the well-known MIPS R4000 implementation, but with 64 rather than 48 entries. This allows up to 128 pages to be mapped ranging in size from 4K bytes to 16M bytes. In an alternative preferred embodiment the page size ranges from 16K Bytes to 16M Bytes. The TLB is shared across all contexts running in the machine, thus software must guarantee that the translations can all be shared. Each context has its own Address Space ID (ASID) register, so it is possible to allow multiple streams to run simultaneously with the same virtual address translating to different physical addresses. Software is responsible for explicitly setting the ASID in each context and explicitly managing the TLB contents.

The TLB has four ports that can be used to translate addresses in each cycle. Two of these are used for instruction fetches and two are used for load and store instructions. The two ports that are used for loads and stores accept two inputs and perform an add prior to TLB lookup. Thus, the address generation (AGEN) logic is incorporated into the TLB for the purpose of data accesses.

Explicit reads and writes to the TLB (which take place as a result of a stream executing one of the four TLB instructions) occur at a maximum rate of one per cycle across all contexts. In order to translate an address the TLB logic needs access to CP0 registers in addition to the address to translate. Specifically, the ASID registers (one per context) and the KSU, and EXL fields (also one per context) are required. These registers and fields are known to the skilled artisan. The TLB maintains the TLB-related CP0 registers, some of which are global (one in the entire processor) and some of which are local (one per context). This is described in more detail below in the section on memory management.

Instruction Queues Overview

The instruction queues are described in detail in the priority document cross-referenced above. They are described briefly again here relative to the SPU.

There are eight instruction queues, one for each context in the XCaliber processor. Each instruction queue contains up to 32 decoded instructions. An instruction queue is organized such that it can write up to eight instructions at a time and can read from two different locations in the same cycle. An instruction queue always contains a contiguous piece of the static instruction stream and it is tagged with two PCs to indicate the range of PCs present.

An instruction queue maintains a pointer to the oldest instruction that has not yet been dispatched (read), and to the newest valid instruction (write). When 4 or 8 instructions are written into an instruction queue, the write pointer is incremented. This happens on the same edge in which the writes occur, so the pointer indicates which instructions are currently available.

When instructions are dispatched, the read pointer is incremented from 1 to 4 instructions. Writes to an instruction queue occur on a clock edge and the data is immediately available for reading. Rotation logic allows instructions just written to be used. Eight instructions are read from the instruction queue in each cycle and rotated according to the number of instructions dispatched. This guarantees that by the end of the cycle, the first four instructions, accounting for up to 4 instructions dispatched, are available.

The second port into an instruction queue is utilized for handling branches. If the instruction at the target location of a branch is in the instruction queue, that location and the three following instructions are read out of the instruction queue at the same time as the instructions that are currently at the location pointed to by the read pointer. When a branch is taken, the first four instructions of the target are available in most cases if they are in the instruction queue.

In the case of dynamic branches (branches through registers), there may be an extra cycle delay between when the branch is resolved and when the target instructions are available for dispatch. If the target of a taken branch is not in the instruction queue, it will need to be fetched from the instruction cache, incurring a further penalty. The details of branch handling are explained below in the pipeline timing section.

An instruction queue retains up to 8 instructions already dispatched so that they can be dispatched again in the case that a short backward branch is encountered. The execution of a branch takes place on the cycle in which the delay slot of a branch is in the Execute stage.

Register Files Overview

There are eight 31-entry register files in the present example, each entry of which is 32-bits wide. These files hold the 31 MIPS general purpose registers (GPRs), registers 1 through 31. Each register file can support eight reads and four writes in a single cycle. Each register file is implemented as two banks of a 4-port memory wherein, on a write, both banks are written with the same data and on a read, each of the eight ports can be read independently. In the case that four instructions are being dispatched from the same context, each having two register operands, eight sources are needed. Register writes take place at the end of the Memory cycle in the case of ALU operations and at the end of the Write-back cycle in the case of memory loads.

In the case of a load miss, the load/store unit (1007 FIG. 1) executes the load when the data comes back from memory and waits for one of the four write ports to become free so that it can write its data. Special mask load and mask store instruction also write to and read from the register file. When one of these instructions is dispatched, the stream is stalled until the operation has completed, so all read and write ports are available. The instruction is sent to the register transfer unit (RTU), which will then have full access to the register file read and write ports for that stream. In the case of a stream which is under PMU control, the RTU also has full access to the register file so that it can execute the preload of a packet into stream registers.

Function Units Overview

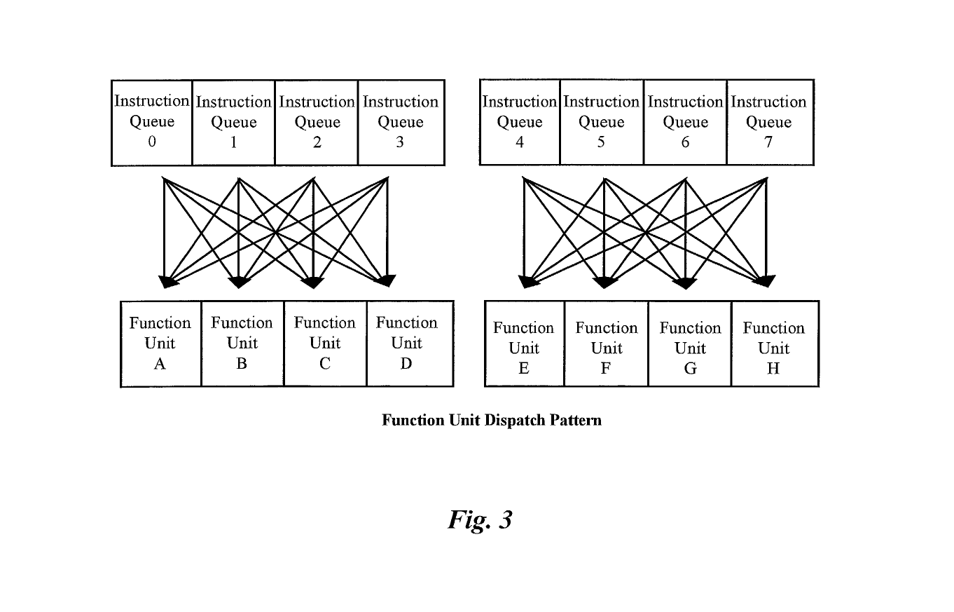

FIG. 3 is a diagram of the arrangement of function units and instruction queues in the XCaliber processor of the present example. There are a total of eight function units shared by all streams. Each stream can dispatch to a subset of four of the function units as shown.

Each function unit implements a complete set of operations necessary to perform all MIPS arithmetic, logical and shift operations, in addition to branch condition testing and special XCaliber arithmetic instructions. Memory address generation occurs within the TLB rather than by the function units themselves.

Function unit A and function unit E shown in FIG. 3 also include a fully pipelined multiplier which takes three cycles to complete rather than one cycle as needed for all other operations. Function units A and E also include one divide unit that is not pipelined. The divider takes between 3 and 18 cycles to complete, so no other thread executing in a stream in the same cluster may issue a divide until it has completed. Additionally, a thread that issues a divide instruction may not issue any other instructions which read from or write to the destination registers (HI and LO) until the divide has completed. A divide instruction may be canceled, so that if a thread starts a divide and then takes an exception on a instruction preceding the divide, the divider is signaled so that its results will not be written to the HI and LO destination registers. Note that while the divider is busy, other ALU operations and multiplies may be issued to the same function unit.

Data Cache Overview

The data cache (1002 in FIG. 1) in the present example is 64K bytes in size, 4-way set associative and has 32-byte lines in a preferred embodiment. Like the instruction cache, the data cache is dually ported, so up to two simultaneous operations (read or write) are permitted on each bank. Physically, the data cache is organized into banks holding 16 bytes of data each and there are a total of 16 such banks (four make up one line and there are four ways). Each bank is therefore 512 entries by 64 bits.

A MIPS load instruction needs at most 4 bytes of data from the data cache, so only four banks need to be accessed for each port (the appropriate 8-byte bank for each of the four ways). There are also four banks which hold tags for each of the 512 sets. All four banks of tags must be accessed by each load or store instruction. There is no parity or ECC in the data cache.

A line in the data cache can be write-through or write-back depending on how it is tagged in the TLB. When an address is translated it is determined if it is cacheable or uncacheable. The data cache consists of 512 sets. The nine-bit set index comes from bits 5-13 of the physical address. A TLB access occurs in advance of the data cache access to translate the virtual address from the address generation logic to the physical address. The tag array contains bits 14-35 of the physical address (22 bits). There is also a two-bit state field associated with each line (which is used to implement three cache line states: Invalid, Clean, and Dirty. During a data cache load, all three ways are accessed for the one bank which contains the target address. Simultaneously the tags for all three ways are accessed. The result of comparing all three tags with the physical address from the TLB is used to select one of the three ways.

The data cache implements true LRU replacement in the same way as described above for the instruction cache, including random replacement in some preferred embodiments. The replacement way is chosen when the data is returned from the SIU. When a store operation is executed, if the cache line is in the data cache, the store data is sent to the appropriate bank with the appropriate write enables activated. Each bank contains byte write enables allowing a Store Byte instruction to be completed without reading the previous contents of the bank. In the case that the line is in the Clean state, it will be changed to the Dirty state. In the case of a store miss, a load of the cache line is sent to the SIU and when the data returns from the SIU, it will be merged with the store data, written into the cache and a new tag entry will be created in the Dirty state.

The Data Cache system in a preferred embodiment of the present invention works with a bypass structure indicated as element 2901 in FIG. 29.

Data cache bypass system 2901 consists, in a preferred embodiment, of a six entry bypass structure 2902, and address matching and switching logic 2903. It will be apparent to the skilled artisan that there may be more or fewer than six entries in some embodiments. This unique system allows continuous execution of loads and stores of arbitrary size to and from the data cache without stalls, even in the presence of partial and multiple dependencies between operations executed in different cycles.

Each valid entry in the bypass structure represents a write operation which has hit in the data cache but has not yet been written into the actual memory array. These data elements represent newer data than that in the memory array and are (and must be) considered logically part of the data cache. In use every read operation utilizes address matching logic in block 2903 to search the six entry bypass structure to determine if any one or more of the entries represents data more recent than that stored in the data cache memory array.

Each memory operation may be 8-bits, 16-bits or 32-bits in size, and is always aligned to the size of the operation. A read operation may therefore match on multiple entries of the bypass structure, and may match only partially with a given entry. This means that the switching logic which determines where the newest version of a given item of data resides must operate based on bytes. A 32-bit read may then get its value from as many as four different locations, some of which are in the bypass structure and some of which are in the data cache memory array itself.

The data cache memory array supports two read or write operations in each cycle, and in the case of writes, has byte write enables. This means that any write can alter data in the data cache memory array without having to read the previous contents of the line in which it belongs. For this reason, a write operation frees up a memory port in the cycle that it is executed and allows a previous write operation, currently stored in the elements of the bypass structure, to be completed. Thus, a total of only six entries (given the 32-bit limitation) are needed to guarantee that no stalls are inserted and the bypass structure will not overflow.

Data cache miss data is provided by the SIU in 16-byte units. It is placed into a line buffer of 32 bytes and when the line buffer is full, the data is written into the data cache. Before the data is written the LRU structure is consulted to find the least recently used way. If that way is dirty, then the old contents of the line are read before the new contents are written. The old contents are placed into dirty Write-back line buffer and a Write-back request is generated to the SIU.

Load/Store Unit Overview

The Load/Store Unit (1007, FIG. 1) is responsible for queuing operations that have missed in the data cache and are waiting for the data to be returned from the SIU. The load/store unit is a special data structure with 32 entries where each entry represents a load or store operation that has missed.

When a load operation is inserted into the load/store unit, the LSU is searched for any other matching entries. If matching entries are found, the new entry is marked so that it will not generate a request to the SIU. This method of load combining allows only the first miss to a line to generate a line fill request. However, all entries must be retained by the load/store unit since they contain the necessary destination information (i.e. the GPR destination and the location of the destination with the line). When the data returns from the SIU it is necessary to search the load/store unit and process all outstanding memory loads for that line.

Store operations are also inserted into the load/store unit and the order between loads and stores is maintained. A store represents a request to retrieve a line just like a load, but the incoming line must be modified before being written into the data cache. If the load/store queue is full, the dispatch logic will not allow any more memory operations to be dispatched.

In the case that a load or store operation takes place to uncached memory, the requests go into a special 8 entry uncached request queue. This special queue does no load combining and retains the exact size (1, 2 or 4 bytes) of the load or store. If the uncached memory queue becomes full, no more memory operations can be dispatched.

Register Transfer Unit Overview

The Register Transfer Unit is responsible for maintaining global state for context ownership. The RTU maintains whether each context is PMU-owned or SPU-owned. The RTU also executes masked-load and masked-store instructions, which are used to perform scatter/gather operations between the register files and memory. These masked operations are a subject of a different patent application. The RTU also executes a packet preload operation, which is used by the PMU to load packet data into a register file before a context is activated.

Pipeline

General

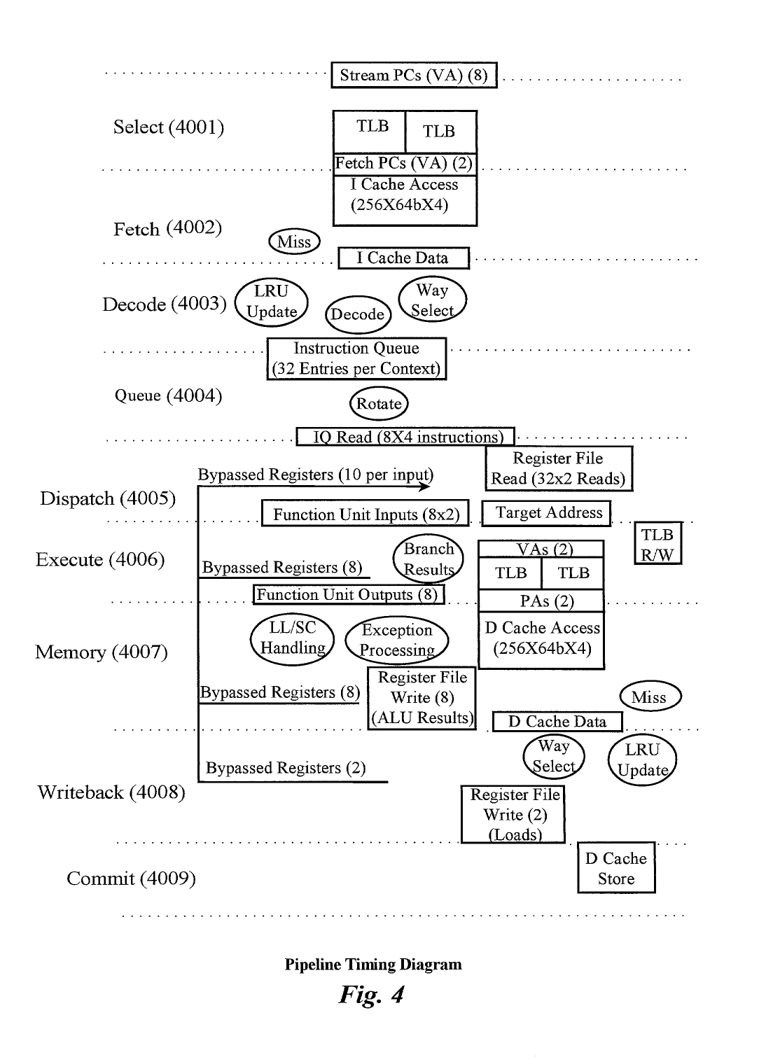

FIG. 4 is a diagram of the steps in SPU pipelining in a preferred embodiment of the present invention. The SPU pipeline consists of nine stages: Select (4001), Fetch (4002), Decode (4003), Queue (4004), Dispatch (4005), Execute (4006), Memory (4007), Write-back (4008) and Commit (4009). It may be helpful to think of the SPU as two decoupled machines connected by the Queue stage. The first four stages implement a fetch engine which endeavors to keep the instruction queues filled for all streams. The maximum fetch bandwidth is 16 instructions per cycle, which is twice the maximum execution rate.

The last five stages of the pipeline implement a Very Long Instruction Word (VLIW) processor in which dispatched instructions from all active threads operating in one or more of the eight streams flow in lock-step with no stalls. The Dispatch stage selects up to sixteen instructions to dispatch in each cycle from all active threads based on flow dependencies, load delays and stalls due to cache misses. Up to four instructions may be dispatched from a single stream in one cycle.

Select Stage

In the Select stage two of the eight contexts are chosen (selected) for fetch in the next cycle. Select-PC logic 1008 (FIG. 1) maintains for each context a Fetch PC (FPC) 1009. The FPCs for the two contexts that are selected are fed into two ports of the TLB and at the end of the Select stage the physical addresses for these two FPCs are known.

The criteria for selecting a stream is based on the number of instructions in each instruction queue. There are two bits of size information that come from each instruction queue to the Select-PC logic. Priority in selection is given to instruction queues with fewer undispatched instructions. If the queue size is 16 instructions or greater, the particular context is not selected for fetch. This means that the maximum number of undispatched instructions in an instruction queue is 23 (15 plus eight that would be fetched from the instruction cache). If a context has generated an instruction cache miss, it will not be a candidate for selection until either there is change in the FPC for that context or the instruction data comes back from the SIU. If a context was selected in the previous cycle, is not selected in the current cycle.

In the case that the delay slot of a branch is passing through the execute stage (to be described in more detail below) in the current cycle, if that branch is taken, and if the target address for that branch is not in any of the other stages, it will possibly be selected for fetch by the Select stage. This is a branch override path in which a target address register (TAR) supplies the physical address to fetch rather than the output of the TLB. This can only be utilized if the target of the branch is in the same 4K page as the delay slot of the branch instruction.

If more than two delay slots are being executed with taken results, the select logic will select two of them for fetch in the next cycle. Note that the target of a taken branch could be in the Dispatch or Execute stages (in the case of short forward branches), in the instruction queue (in the case of short forward or backward branches), or in the Fetch or Decode stages (in the case of longer forward branches). Only if the target address is not in any other stage will the Select-PC logic utilize the branch override path.

Fetch Stage

In the Fetch stage the instruction cache is accessed, and either 16 or 32 bytes are read for each of two threads, in each of the four ways. The number of bytes that are read and which bytes is dependent on the position of the FPC within the 64-byte line as follows:

PC points to bytes 0, 4, 8, 12: fetch bytes 0-31

PC points to bytes 16, 20, 24, 28: fetch bytes 16-48

PC points to bytes 32, 36, 40, 44: fetch bytes 32-63

PC points to bytes 48, 52, 56, 60: fetch bytes 48-63

Each 16 byte partial line is stored in a separate physical bank. This means there are 16 banks for the data portion of the instruction cache, one for each 1/4 line, and one for each way. Each bank contains 256 entries (one entry for each set) and the width is 128 bits.

In the Fetch stage, two of the four banks are enabled for each set and for each port, and the 32-byte result for each way is latched at the end of the cycle. The Fetch stage thus performs bank selection. Way selection is performed in the following cycle.

In parallel with the data access, the tag array is accessed and the physical address which was generated in the Select stage is compared to the four tags to determine if the instruction data for the fetch PC is contained in the instruction cache. In the case that none of the four tags match the physical address, a miss notation is made for that fetch PC and the associated stream is stalled for fetch. This also causes the fetch PC to be reset in the current cycle and prevents the associated context from being selected until the data returns from the SIU or the FPC is reset. No command is sent to the SIU until it is known that the line referenced will be needed for execution, in the absence of exceptions or interrupts. This means that if there are instructions in the pipeline ahead of this instruction, only when there are no branches will the miss be sent to the SIU. Thus, no speculative reads are sent to the SIU. In the case of a taken branch, there will be no valid instructions ahead in the pipeline, so the miss can be sent to the SIU immediately.

When data returns from the SIU, it is delivered at a rate of 16 bytes per cycle, and written into the instruction cache one entire line at a time. This ties up one of the two ports into the instruction cache for a specific way and also one port into one of the tag banks. Bypass logic allows the data that is being written to be used for instruction fetch. If one of the contexts is waiting for an instruction in the line being written, that context is selected for fetch and its data into the bank selection multiplexers comes from the data being written rather than from the memory itself. In the cycle in which the write occurs, the other port can be used to fetch another context. However, logic also checks to verify that the other line being read differs from the line being written.

Decode Stage

In the Decode stage way selection and decoding occurs. In the event that one or both of the two fetches that occurred in the previous cycle hit in the instruction cache, the way for which the hit occurs was latched. This way number is fed into the way selection multiplexer which selects the appropriate 32 bytes from the four ways. This occurs for each of the two accesses, so up to 16 instructions are delivered in each cycle.

The selected instructions are decoded before the end of the cycle. In the case that the fetch PC is in the last 4 instructions (16 bytes) of a line, only four instructions are delivered for that stream. By the end of the Decode stage, the 4 or 8 instructions fetched in the previous cycle are set up for storage into the instruction queue in the following cycle. During decoding, each of the 32-bit instructions is expanded into a decoded form that contains approximately 41 bits.

In parallel with way selection and decoding, the LRU state is updated as indicated in the previous section. For the zero, one or two ways that hit in the instruction cache in the previous cycle, the 6-bit entries are updated. If a write occurred on one port in the previous cycle, it's way is set to MRU, regardless of whether or not a bypass occurred.

Queue Stage

At the beginning of the Queue stage the 0, 4 or 8 instructions which were decoded in the previous cycle are written into the appropriate instruction queue. Up to two contexts get new instructions written into them in the Queue stage. The data which is written at the beginning of the cycle is immediately available for reading, so no bypass is needed. Along with the decoded instructions, the physical and virtual addresses are delivered to the instruction queue so it can update its address tags.

The eight instructions which are at the head of the instruction queue are read during the Queue stage and a rotation is performed before the end of the cycle. This rotation is done such that depending on how many instructions are dispatched in this cycle (0, 1, 2, 3 or 4), the oldest four instructions yet to be dispatched, if available, are latched at the end of the cycle.

In parallel with the instruction queue read and rotation, the target address register is compared to the virtual address for each group of four instructions in the instruction queue. If the target address register points to instructions currently in the instruction queue, the instruction at the target address and the following three instructions will also be read from the instruction queue. If the delay slot of a branch is being executed in the current cycle, a signal may be generated in the early part of the cycle indicating that the target address register is valid and contains a desired target address. In this case, the four instructions at the target address will be latched at the end of the Queue stage instead of the four instructions which otherwise would have been.

However, if the target address register points to an instruction which is after the delay slot and is currently in the Execute stage, the set of instructions latched at the end of the Queue stage will not be affected, even if that target is still in the instruction queue. This is because the branch can be handled within the pipeline without affecting the Queue stage. Furthermore, if the target address register points to an instruction which is currently one of the four in the Queue output register, and if that instruction is scheduled for dispatch in the current cycle, again the Queue stage will ignore the branch resolution signal and will merely rotate the eight instructions it read from the instruction queue according to the number of instructions that are dispatched in the current cycle. But if the target instruction is not scheduled for dispatch, the Queue stage rotation logic will store the target instruction and the three instructions following it at the end of the cycle.

Dispatch Stage

In the Dispatch stage, the register file is read, instructions are selected for dispatch, and any register sources that need to be bypassed from future stages in the pipeline are selected. Since each register file can support up to eight reads, these reads can be made in parallel with instruction selection. For each register source, there are 10 bypass inputs from which the register value may come. There are four inputs from the Execute stage, four inputs from the Memory stage and two inputs from the Write-back stage. The bypass logic must compare register results coming from the 10 sources and pick the most recent for a register that is being read in this cycle. There may be multiple values for the same register being bypassed, even within the same stage. The bypass logic must take place after Execute cycle nullifications occur. In the case of a branch or a conditional move instruction, a register destination for a given instruction may be nullified. This will take place, at the latest, approximately half way into the Execute cycle. The correct value for a register operand may be an instruction before or after a nullified instruction.

Also in the Dispatch stage the target address register is loaded for any branch that is being dispatched. The target address is computed from the PC of the branch +4, an immediate offset (16 or 26 bits) and a register, depending on the type of branch instruction. One target address register is provided for each context, so a maximum of one branch instruction may be dispatched from each context. More constraining, the delay slot of a branch must not be dispatched in the same cycle as a subsequent branch. This guarantees that the target address register will be valid in the same cycle that the delay slot of a branch is executed.

Up to four instructions can be dispatched from each context, so up to 32 instructions are candidates for issue in each cycle. The instruction queues are grouped into two sets of four, and each set can dispatch to an associated four of the function units. Dispatch logic selects which instructions will be dispatched to each of the eight function units. The following rules are used by the dispatch logic to decide which instructions to dispatch:

1. There may be only two load or store instructions for all contexts, and both may come from the same context, except that a load may not be issued after a store from the same context (i.e. two loads, two stores or a load and then a store may be issued from the same context).

2. To preserve flow dependencies, ALU operations cause no delay but break dispatch; memory loads cause a two cycle delay. This means that on the third cycle, an instruction dependent on the load can be dispatched as long as no miss occurred. If a miss did occur, an instruction dependent on the load must wait until the line is returned from the SIU and the load is executed by the load/store unit.

3. If either of the load/store queues is full (or could be full based on what has issued), no memory instructions may be issued. Similarly if the bypass queue is full, or could be full based on what has issued, no memory instructions may be issued.

4. The delay slot of a branch may not be issued in the same cycle as a subsequent branch instruction.

5. One PMU instruction may be issued per cycle in each cluster and may only be issued if it is at the head of its instruction queue. There is also a full bit associated with the PMU command register such that if set, that bit will prevent a PMU instruction from being dispatched from that cluster. Additionally, since PMU instructions cannot be undone, no PMU instructions are issued unless the context is guaranteed to be exception free (this means that no TLB exceptions, and no ALU exceptions are possible, however it is OK if there are pending loads). In the special case of a Release instruction, the stream must be fully synced, which means that all loads are completed, all stores are completed, the packet memory line buffer has been flushed, and no ALU exceptions are possible.

6. The instruction after a SYNC instruction may not be issued until all loads are completed, all stores are completed, and no ALU exceptions are possible for that particular stream. The SYNC instruction is consumed in the issue stage and doesn't occupy a function unit slot.

7. For multiply and divide instructions, it is OK to issue non-dependent instructions since no exception can be generated, but they can only be dispatched if they are at the head of their respective queues. Dependent instructions on a multiply (HI/LO registers) wait two cycles, instructions dependent on a divide will wait up to 18 cycles.

8. One CP0 or TLB instruction (probe, read, write indexed or write random) is allowed per cycle from each cluster, and only if that instruction is at the head of its instruction queue. There is also a full bit associated with the TLB command register such that if set, it will prevent a TLB instruction from being dispatched by that cluster.

9. There are only four writes into the register files, but loads and non-loads count as write ports in different cycles.

10. The LDX and STX instructions will stall the stream and prevent dispatch of the following instruction until the operation is complete. These instructions are sent to the RTU command queue and therefore dispatch of these instructions is prevented if that queue is full.

11. The SIESTA instruction is handled within dispatch by stalling the associated stream until the count has expired.

The priority of instructions being dispatched is determined by attempting to distribute the dispatch slots in the most even way across the eight contexts. In order to prevent any one context from getting more favorable treatment from any other, a cycle counter is used as input to the scheduling logic.

Execute Stage

In the Execute stage ALU results are computed for logical, arithmetic and shift operations. ALU results are available for bypass before the end of the cycle, insuring that an instruction dependent on an ALU result can issue in the cycle after the ALU instruction. In the case of memory operations, the virtual address is generated in the first part of the Execute stage and the TLB lookup follows. Multiply operations take three cycles and the results are not bypassed, so there is a two cycle delay between a multiply and an instruction which reads from the HI and LO registers.

When a branch instruction is executed, the result of its comparison or test is known in the early part of the Execute cycle. If the delay slot is also being executed in this cycle, then the branch will take place in this cycle, which means the target address register will be compared with the data in various stages as described above. If the delay slot is not being executed in this cycle, the branch condition is saved for later use. One such branch condition must be saved for each context. When at some later point the delay slot is executed, the previously generated branch condition is used in the execution of the branch.

In some cases, instruction results are invalidated during the Execute stage so they will not actually write to the destination register which was specified. There are three situations in which this occurs: 1. a conditional move instruction in which the condition is evaluated as false, 2. the delay slot of a branch-likely instruction in which the branch is not taken, and 3. an instruction dispatched in the same cycle as the delay slot of the preceding branch instruction in which the branch is taken. When a register destination is invalidated during the Execute stage, the bypass logic in the Dispatch stage must receive the invalidation signal in enough time to guarantee that it can bypass the correct value from the pipeline.

Memory Stage

In the Memory stage the data cache is accessed. Up to two memory operations may be dispatched across all streams in each cycle. In the second half of the Memory stage the register files are written with the ALU results generated in the previous cycle.

Before register writes are committed to be written, which takes place half way through the memory stage, exception handling logic insures that no TLB, address or arithmetic exceptions have occurred. If any of these exceptions have been detected, then some, and possibly all, of the results that would have been written to the register file are canceled so that the previous data is preserved. The exceptions that are detected in the first half of the Memory stage are the following: TLB exceptions on loads and stores, address alignment exceptions on loads and stores, address protection exceptions on loads and stores, integer overflow exceptions, traps, system calls and breakpoints.

In the case that instructions after the instruction generating the exception were also executed in the previous cycle, their register destinations, if any are also inhibited. In the case that instructions before the instruction generating the exception were also executed in the previous cycle, their register destinations, if any, are allowed to be written. Instructions which are currently in the Execute stage for the context that generated the exception are all invalidated and Dispatch is inhibited from dispatching any more instructions from this stream in the current cycle.

Note that it is possible to get certain types of memory exceptions, such as those that are generated by the SIU, such as bus errors and ECC uncorrectable errors on pending memory operations after the Memory stage. In these cases, since instructions after the instruction which generated the exception may have already been committed, these exceptions are imprecise.

Write-back Stage

In the Write-back stage the output of the tags from the data cache is matched against the physical addresses for each access. In the Write-back cycle, the results of a load are written to the register file. A load result may be invalidated by an instruction which wrote to the same register in the previous cycle (if it was a later instruction which was dispatched in the same cycle as the load), or by an ALU operation which is being written in the current cycle. The register file checks for these write-after-write hazards and guarantees correctness. In addition, for every load which misses in the cache and gets later executed by the load/store unit, the fact of whether or not the destination register has been overwritten by a later instruction is recorded so that the load result can be invalidated.

Commit Stage

In the Commit stage, data for store instructions is written into the Data Cache.

Instruction Set

The XCaliber processor implements most 32-bit instructions in the MIPS-IV architecture with the exception of floating point instructions. All instructions implemented are noted below with differences pointed out where appropriate.

The XCaliber processor implements a one cycle branch delay, in which the instruction after a branch is executed regardless of the outcome of the branch (except in the case of branch-likely instructions in which the instruction after the branch is skipped in the case that the branch is not taken).

In the case of loads from memory, there is a two cycle load delay implemented in hardware. The programmer and/or compiler is free to place an instruction dependent on a load immediately after the load and the hardware will guarantee correct results. Note that the two cycle load delay is two machine cycles, which is separate from the progress being made on a particular stream. This means that if the programmer and/or compiler is unable to separate a load from a dependent instruction, the XCaliber processor is likely be able to get useful work done in other threads during the delay. Thus a two cycle load delay does not represent a two cycle machine stall in the case that there are no instructions between the load and the first dependent instruction. Also note that there could be up to 11 non-dependent instructions dispatched between a load and its dependent instruction (since up to four instructions can be dispatched from each thread in each cycle). In the case of a miss to the cache, the load delay is longer. Dependent instructions will wait until the data returns from the SIU. Note that the XCaliber processor dispatches all instructions in order. This means that any flow dependency will prevent further instructions from being issued from that thread until the dependency is resolved. The XCaliber processor runs in 32-bit mode only. There are no 64-bit registers and no 64-bit instructions defined. All of the 64-bit instructions generated reserved instruction exceptions.

Control Flow Instructions
All of the standard MIPS branch, jump and trap instructions are
implemented by the XCaliber Processor. These instructions are listed
below. A branch may not be placed in the delay slot of another branch.
Unconditional jumps

| | |
|---|---|
| J | dest = offset26 + PC |
| JAL | dest = offset26 + PC, return PC to r31 |
| JR | dest = register |
| JALR | dest = register, return PC to r31 |

Conditional branches comparing two registers for equality

| | |
|---|---|
| BEQ | dest = offset16 + PC |
| BEQL | dest = offset16 + PC, nullify delay if NT |
| BNE | dest = offset16 + PC |
| BNEL | dest = offset16 + PC, nullify delay if NT |

Conditional branches testing one register (sign bit and for zero)

| | |
|---|---|
| BGTZ | dest = offset16 + PC |
| BGTZL | dest = offset16 + PC, nullify delay if NT |
| BLEZ | dest = offset16 + PC |
| BLEZL | dest = offset16 + PC, nullify delay if NT |
| BLTZ | dest = offset16 + PC |
| BLTZL | dest = offset16 + PC, nullify delay if NT |
| BLTZAL | dest = offset16 + PC, return PC to r31 |
| BLTZALL | dest = offset16 + PC, return PC to r31, |

nullify delay if NT

| | |
|---|---|
| BGEZ | dest = offset16 + PC |
| BGEZL | dest = offset16 + PC, nullify delay if not |

taken

| | |
|---|---|
| BGEZAL | dest offset16 + PC, return PC to r31 |
| EGEZALL | dest offset16 + PC, return PC to r31, |

nullify delay if NT
Conditional traps comparing two registers for equality and magnitude

| | |
|---|---|
| TEQ | dest = 0×80000180 |
| TNE | dest = 0×80000180 |
| TGE | dest = 0×80000180 |
| TGEU | dest = 0×80000180 |
| TLT | dest = 0×80000180 |
| TLTU | dest = 0×80000180 |

Conditional traps comparing one register with an immediate for
equality and magnitude

| | |
|---|---|
| TGEI | dest = 0×80000180 |
| TGEIU | dest = 0×80000180 |
| TLTI | dest = 0×80000180 |
| TLTIU | dest = 0×80000180 |
| TEQI | dest = 0×80000180 |
| TNEI | dest = 0×80000180 |

Miscellaneous control flow instructions

| | |
|---|---|
| SYSCALL | dest = 0×80000180 |
| BREAK | dest = 0×80000180 |

Note that five instructions listed above have a register destination (r31) as well as a register source. These instructions are JALR, BLTZAL, BLTZALL, BGEZAL and BGEZALL. These instructions should not be programmed such that r31 is a source for the instruction. Exception handling and interrupt handling depends on an ability to return to the flow of a stream even if that stream has been interrupted between the branch and the delay slot. This requires a branch instruction to be re-executed upon return. Thus, these branch instructions must not be written in such a way that they would yield different results if executed twice.

Memory Instructions

The basic 32-bit MIPS-IV load and store instructions are implemented by the XCaliber processor. These instructions are listed below. Some of these instructions cause alignment exceptions as indicated. The two instructions used for synchronization (LL and SC) are described in more detail in the section on thread synchronization. The LWL, LWR, SWL and SWR instructions are not implemented and will generate reserved instruction exceptions.

Loads

| | |
|---|---|
| LB | target = offset16 + register |
| LBU | target = offset16 + register |
| LH | target = offset16 + register (must be |

16-bit aligned)

| | |
|---|---|
| LHU | target = offset16 + register (must be |

16-bit aligned)

| | |
|---|---|
| LW | target = offset16 + register (must be |

32-bit aligned)
Stores

| | |
|---|---|
| SB | target = offset16 + register |
| SH | target = offset16 + register (must be |

16-bit aligned)

| | |
|---|---|
| SW | target = offset16 + register (must be |

32-bit aligned)
Synchronization primitives

| | |
|---|---|
| LL | target = offset16 + register |
| | (must be 32-bit aligned) |
| SC | target =offset16 + register |
| | (must be 32-bit aligned) |

Masked Load/Store Instructions

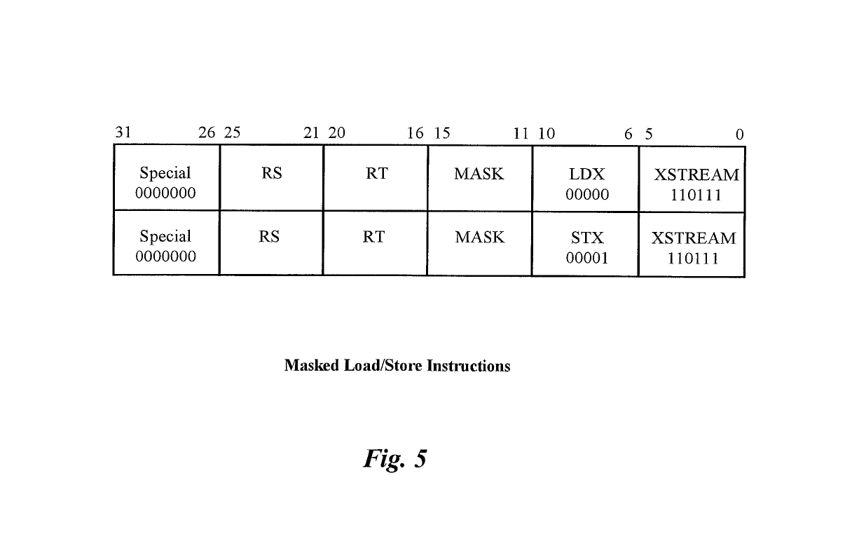

FIG. 5 is a diagram illustrating the Masked Load/Store Instructions. The LDX and STX instructions perform masked loads and stores between memory and the general purpose registers. These instructions can be used to implement a scatter/gather operation or a fast load or store of a block of memory.

The assembly language format of these instructions is as follows:

LDX rt, rs, mask

STX rt, rs, mask

The mask number is a reference to the pattern which has been stored in the pattern memory. There are a total of 32 masks, 24 of which are global and can be used by any context, and eight of which are context specific. This means that each context can access 25 of the 32 masks.

If the mask number in the LDX or STX instruction is in the range 0-23, it refers to one of the global masks. If the mask number is equal to 31, the context-specific mask is used. The context-specific mask may be written and read by each individual context without affecting any other context. Mask numbers 24-30 are undefined in the present example.

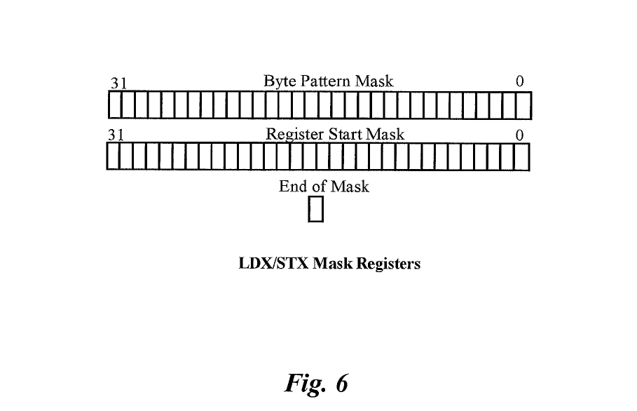

FIG. 6 shows the LDX/STX Mask registers. Each mask consists of two vectors of 32 bits each. These vectors specify a pattern for loading from memory or storing to memory. Masks 0-22 also have associated with them an end of mask bit, which is used to allow multiple global masks to be chained into a single mask of up to eight in length. The physical location of the masks within PMU configuration space can be found in the PMU architecture document.

The LDX and STX instructions bypass the data cache. This means that software is responsible for executing these instructions on memory regions that are guaranteed to not be dirty in the data cache or results will be undefined. In the case of packet memory, there will be no dirty lines in the data cache since packet memory is write-through with respect to the cache. If executed on other than packet memory, the memory could be marked as uncached, it could be marked as write-through, or software could execute a “Hit Write-back” instruction previous to the LDX or STX instruction.

The following rules apply to the use of the LDX/STX instruction:

1. Bytes corresponding to 0's in the mask may or may not be read by an LDX instruction. Software should guarantee that the memory locations corresponding to LDX memory do not generate side effects on reads.

2. If there are more than four 1's in the Byte Patten Mask between two 1's in the Register Start Mask, the contents of the associated register are undefined upon execution of an LDX instruction.

3. If R0 is the destination for an LDX instruction, no registers are written and all memory locations, even those with 1's in the Byte Pattern Mask may or may not be read.

4. If R0 is the source for STX, zeros are written to every mask byte.

5. If more than R31 is specified on a LDX, no additional registers are modified and 1 's above may or may not be read.

6. If more than R31 is specified on STX, no additional writes to memory take place.

7. If a 0 is in the Byte Patten Mask, the contents of that location in the Register Start Mask must be 0.

8. The first 1 in the Byte Pattern Mask must have a 0 in corresponding location in the Register Start Mask.(only on the first mask if masks are chained).

9. Maximum of eight chained masks, stop at eight even if EOM not set.

10. Chaining doesn't occur past mask #23, so EOM is not present for mask #23, it is defined always to be set.

11. Context specific masks cannot be chained, there is no EOM bit on those masks.

Miscellaneous Memory Instructions

SYNC

Cache

The CACHE instruction implements the following five operations:

| | |
|---|---|
| 0: | Index Invalidate - Instruction Cache |
| 1: | Index Write-back Invalidate - Data Cache |
| 5: | Index Write-back Invalidate - Data Cache |
| 9: | Index Write-back - Data Cache |
| 16: | Hit Invalidate - Instruction Cache |
| 17: | Hit Invalidate - Data Cache |
| 21: | Hit Write-back Invalidate - Data Cache |
| 25: | Hit Write-back - Data Cache |
| 28: | Fill Lock - Instruction Cache |
| 29: | Fill Lock - Data Cache |

The Fill Lock instructions are used to lock the instruction and data caches on a line by line basis. Each line can be locked by utilizing these instructions. The instruction and data caches are four way set associative, but software should guarantee that a maximum of three of the four lines in each set are locked. If all four lines become locked, then one of the lines will be automatically unlocked by hardware the first time a replacement is needed in that set.

Arithmetic, Logical and Shift Instructions

All 32-bit arithmetic, logical and shift instructions in the MIPS-IV architecture are implemented by the XCaliber processor. These instructions are listed below.

(1) Arithmetic/Logical Instructions with Three Register Operands

These instructions have rs and rt as source operands and write to rd as a destination. The latency is one cycle for each of these operations.

AND

OR

XOR

NOR

ADD

ADDU

SUB

SUBU

SLT

SLTU

(2) Arithmetic/Logical Instructions with Two Register Operands and an Immediate

These instructions have rs as a source operand and write to rt as a destination. The latency is one cycle for each of these operations.

ANDI

ORI

XORI

ADDI

ADDIU

SLTI

SLTIU

(3) Shift Instructions with a Static Shift Amount

SLL

SRL

SRA

(4) Shift Instructions with a Dynamic Shift Amount

SLLV

SRLV

SRAV

(5) Multiply and Divide:

MULT

MULTU

DIV

DIVU

(6) Conditional Move Instructions:

MOVZ

MOVN

(7) Special Arithmetic Instructions

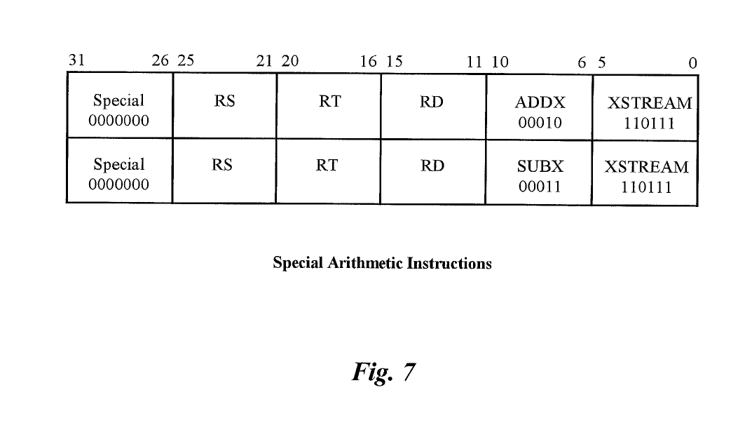

FIG. 7 shows two special arithmetic instructions.

The assembly language format for these instructions is as follows:

ADDX rd, rs, rt

SUBX rd, rs, rt

The ADDX and SUBX instructions perform 1's complement addition and subtraction on two 16-bit quantities in parallel. These instructions are used to compute TCP and IP checksums.

(8)

Miscellaneous ALU Instructions

| | |
|---|---|
| MFHI | register dest |
| MFLO | register dest |
| MTHI | register source |
| MTLO | register source |
| LUI | register dest |

Coprocessor Instructions

No floating point instructions are implemented on the XCaliber processor and coprocessors 2 and 3 are undefined. All coprocessor 1, 2 and 3 instructions generate a “coprocessor unusable” exception. (NB: some may generate reserved instruction exceptions instead). All of the branch on coprocessor 0 instructions produce reserved instruction exceptions. However, all of the TLB instructions, the coprocessor 0 move instructions and the ERET instruction are all implemented.

TLB Instructions

TLBR

TLBWI

TLBWR

TLBP

Return from Exceptions

ERET

Moves to and from Coprocessor Registers

MFCO

MTCO

Siesta Instruction

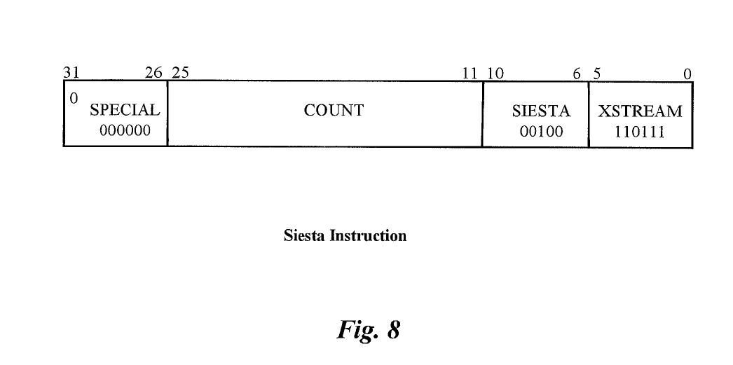

FIG. 8 illustrates a special instruction used for thread synchronization.

The assembly language format of this instructions is as follows:

SIESTA COUNT

The SIESTA instruction causes the context to sleep for the specified number of cycles, or until an interrupt occurs. If the count field is all 1's (Ox7FFF), the context will sleep until an interrupt occurs without a cycle count. A SIESTA instruction may not be placed in the delay slot of a branch. This instruction is used to increase the efficiency of busy-waits. More details on the use of the SIESTA instruction are described below in the section on thread synchronization.

PMU Instructions

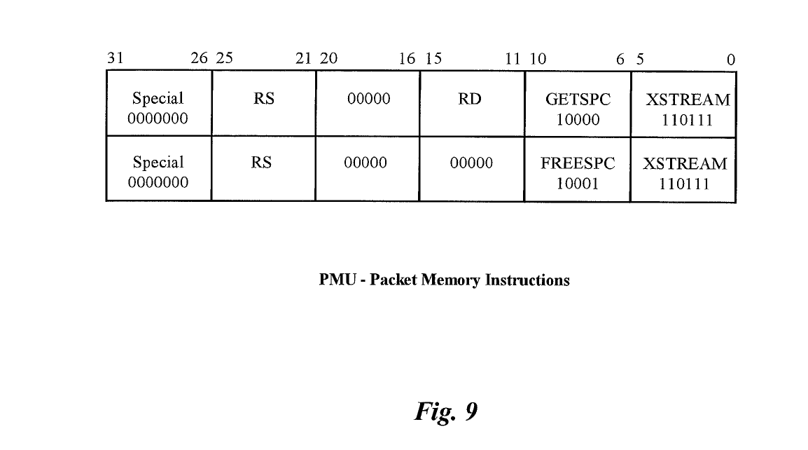

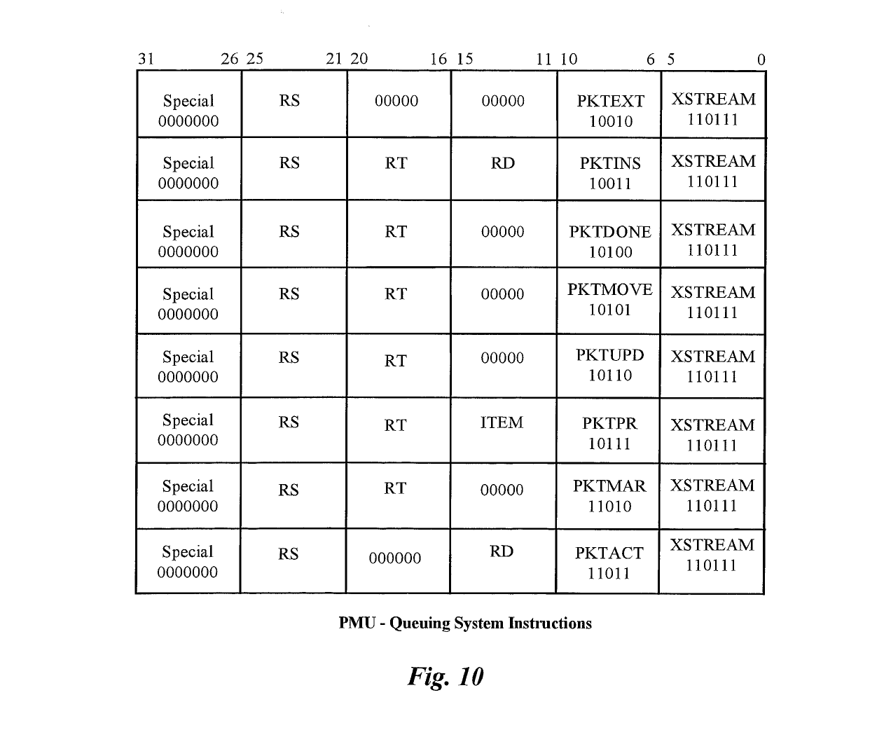

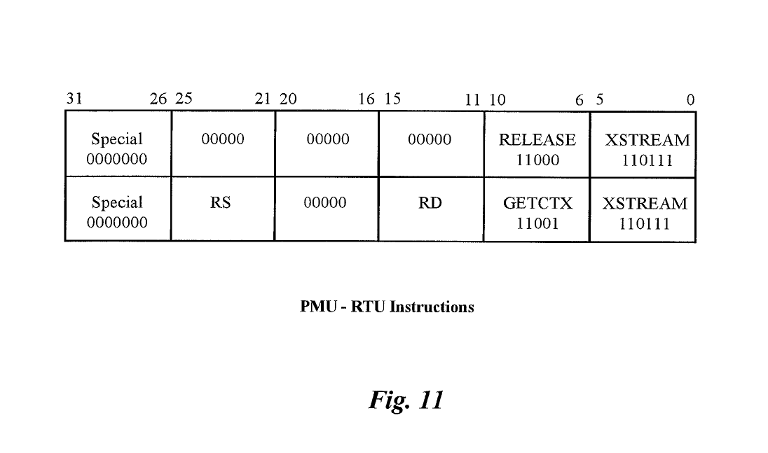

PMU instructions are divided into three categories: packet memory instructions, queuing system instructions and RTU instructions, which are illustrated in FIGS. 9, 10, and 11 respectively. These instructions are described in detail below in a section on PMU/SPU communication.

Memory Management

XCaliber implements an on-chip memory management unit (MMU) similar to the MIPS R4000 in 32-bit mode. An on-chip translation lookaside buffer (TLB) (1003, FIG. 1) is used to translate virtual addresses to physical addresses. The TLB is managed by software and consists of a 64-entry, fully associative memory where each entry maps two pages. This allows a total of 128 pages to be mapped at any given time. There is one TLB on the XCaliber processor that is shared by all contexts and is used for instruction as well as data translations. Up to four translations may take place in any given cycle, so there are four copies of the TLB. Writes to the TLB update all copies simultaneously.

Virtual and Physical Address Spaces

Within the 4 GB of virtual address space, the MIPS R4000 32-bit address spaces are implemented in the XCaliber processor. This includes user mode, supervisor mode and kernel mode, and mapped and unmapped, as well as cached and uncached regions. The location of external memory within the 36-bit physical address space is configured in the SIU registers.

XCaliber Vectors

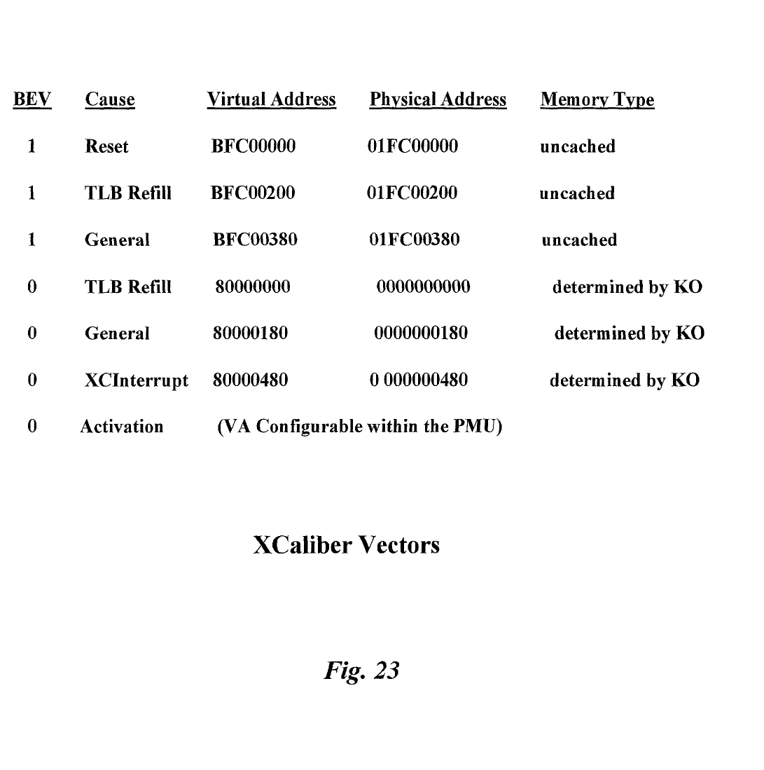

The vectors utilized by the XCaliber processor are shown in the table presented in the drawing set as FIG. 23. XCaliber has no XTLB exceptions and there are no cache errors, so those vectors are not utilized. XC Interrupt and Activation exceptions are disables when BEV=1. Address errors refer to alignment errors as well as to protection errors.

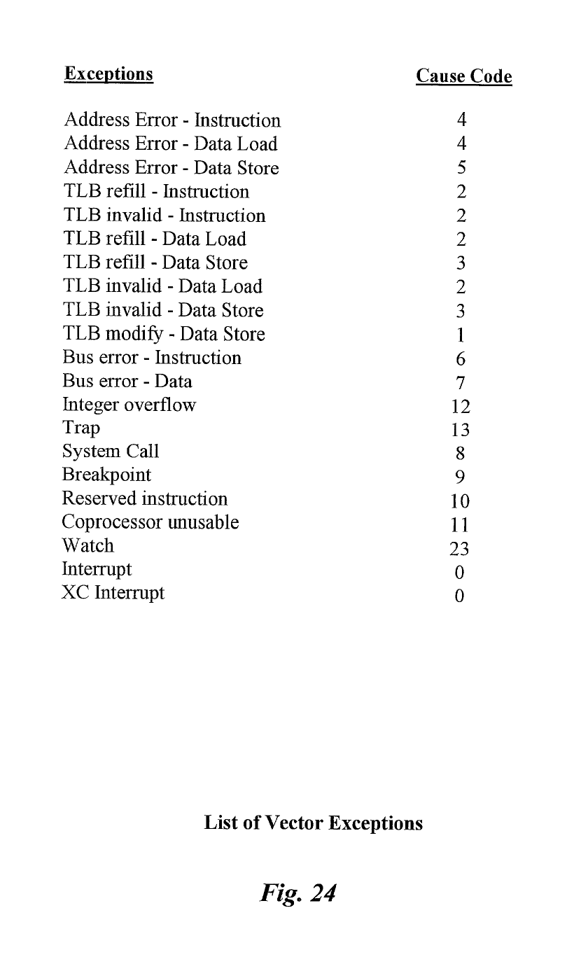

The table presented as FIG. 24 is the list of exceptions and their cause codes.

Packet Memory Addressing

The XCaliber processor defines up to 16 Mbytes of packet memory, with storage for 256K bytes on-chip. The physical address of the packet memory is defined by the SIU configuration, and that memory is mapped using regular TLB entries into any virtual address. The packet memory is 16 Mbyte aligned in physical memory. The packet memory should be mapped to a cacheable region and is write-through rather than write-back. Since the SPU has no way to distinguish packet memory from any other type of physical memory, the SIU is responsible for notifying the SPU upon return of the data that it should be treated in a write-through manner. Subsequent stores to the line containing that data will be written back to the packet memory.

In some applications, it may be desirable to utilize portions of the on-chip packet memory as a directly controlled region of physical memory. In this case a piece of the packet memory becomes essentially a software-managed second-level cache. This feature is utilized through the use of the Get Space instruction, which will return a pointer to on-chip packet memory and mark that space as unavailable for use by packets. Until that region of memory is released using the Free Space instruction, the SPU is free to make use of that memory.

Multi-threaded TLB Operation

The XCaliber processor allows multiple threads to process TLB miss exceptions in parallel. However, since there is only one TLB shared by all threads, software is responsible for synchronizing between threads so the TLB is updated in a coherent manner.

The XCaliber processor allows a TLB miss to be processed by each context by providing local (i.e. thread specific) copies of the Context, EntryHi and BaddV Addr registers, which are loaded automatically when a TLB miss occurs. Note that the local copy of the EntryHi register allows each thread to have its own ASID value. This value will be used on each access to the TLB for that thread.

For a TLB update, software must guarantee that the same page pair does not get loaded into the TLB into different locations. Since two streams can miss simultaneously on the same page, this requires setting a lock and executing a TLB probe instruction to determine if another stream has already loaded the entry that missed. Sample code is illustrated below:

| ; | TLB Miss Entry Point | |
|---|---|---|
| ; | | |
| ; | fetch TLB entry from external page table | |
| ; | (this assumes the Context register has been pre-loaded | |
| ; | with the PTE base in the high bits) | |
| L0: | mfc0 | r1 C0_CONTEXT |
| | 1w | r2, 0(r1) |
| | 1w | r3, 8(r1) |
| ; | | |
| ; | get TLB lock, busy wait if set (wait will be short) | |
| L1: | l1 | r1, (TLB_LOCK) |
| | bne | r1, 0, L1 |
| | ori | r1, 0, #1 |
| | sc | r1, (TLB_LOCK) |
| | beq | r1, 0, L1 |
| | nop | |
| ; | | |
| ; | probe TLB to see if entry has already been written | |
| ; | (local copy of EntryHi is loaded by hardware with VPN of | |
| ; | address that missed for this thread) | |
| ; | | |
| | tlbp | |
| | mfc0 | r1 C0_INDEX |
| | bgez | r1, L2 |
| | nop | |
| ; | | |
| ; | probe was unsuccessful, load TLB, clear lock and return | |
| ; | (this assumes that the PageMask register has been | |
| ; | pre-loaded with the appropriate page size). | |
| ; | | |
| | mtc0 | r2, C0_ENTRYLO0 |
| | mtc0 | r3, C0_ENTRYLO1 |
| | tlbwr | |
| ; | | |
| ; | fall through from above, also branch point when probe | |
| ; | was successful, clear lock and return | |
| L2: | sw | r0, (TLB_LOCK) |
| | eret | |

In the case that the TLB entry has already been loaded by another stream, there are six instructions between the set of the lock and the clear of the lock while in the other case there are nine. This is probably few enough instructions that a SIESTA instruction is not warranted (see the section on thread synchronization for more details).

ASID Usage

The Address Space ID (ASID) field of the EntryHi register is pre-loaded with 0 for all contexts upon thread activation. If the application requires that each thread run under a different ASID, the thread activation code must load the ASID with the desired value. For example, suppose all threads share the same code. This would mean that the G bit should be set in all pages containing code. However, each thread may need its own stack space while it is running. Assume there are eight regions pre-defined for stack space, one for each running context. Page table entries which map this stack space is set with the appropriate ASID value. In this case, the thread activation code must load the ASID register with the context number as follows:

mfc0 r1, c0_thread

mtc0 r1, c0_entryhi

There is one EntryHi register for each context, and reading the Thread number register returns the context number (0-7).

Summary of Memory Management CP0 Registers

Global:

Index (0)

Random (1)

EntryLo0 (2)

EntryLo1 (3)

PageMask (5)

Wired (6)

Local (one per context):

Context (4)

BadV Addr (8)

EntryHi (10)

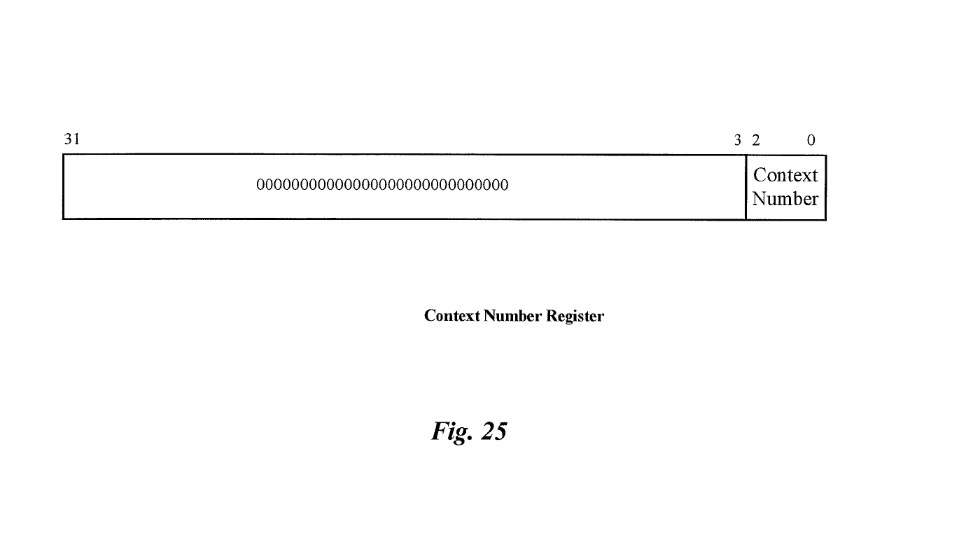

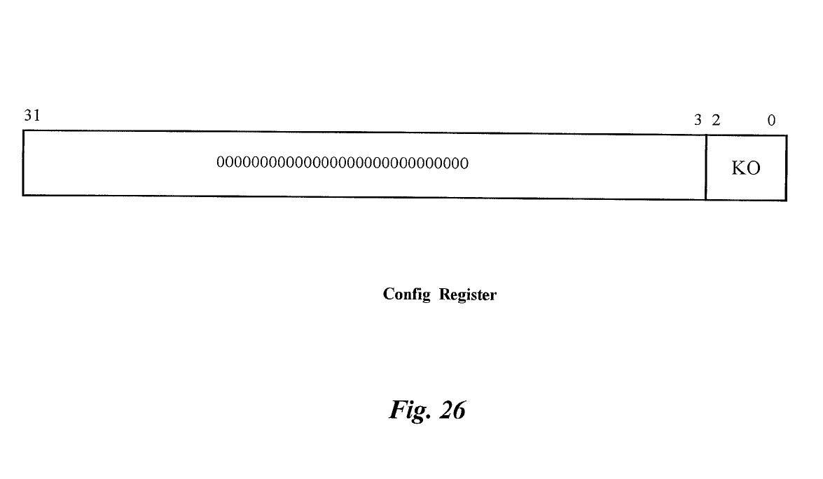

There are two additional CP0 registers; a Context Number Register, as illustrated in FIG. 25; and a Config Register as illustrated in FIG. 26.

MMU Instructions

The XCaliber processor implements the four MIPS-IV TLB instructions consistent with the R4000. These instructions are as follows:

(1) TLB Write Random

EntryHi, EntryLo0, EntryLo1 and PageMask are loaded into the TLB entry pointed to by the Random register. The Random register counts down one per cycle, down to the value of Wired. Note that since only one TLBWR can be dispatched in a cycle. This will guarantee that two streams executing TLBWR instructions in consecutive cycles will write to different locations.

(2) TLB Probe

Probe the TLB according to values of EntryHi. The probe instruction sets the P bit in the index register, which will be clobbered by another stream also executing a probe since there is only one index register. Software must guarantee that this doesn't happen through explicit synchronization.

(3) TLB Read Indexed

There is only one index register, thus multiple streams executing this instruction will read from the same place, but the result of the read (entryhi, entrylo0, entrylo1 and pagemask) are all local so the instruction itself doesn't clobber anything global. Software must explicitly synchronize on modifications to the Index register.

(4) TLB Write Indexed

EntryHi, EntryLo0, EntryLo1 and PageMask are loaded into the TLB entry pointed to by the Index register. There is only one index register, so the write instruction if executed by multiple streams will write to the same location, with different data since the four source registers of the write indexed instruction are local. Software must explicitly synchronize on modifications to the Index register.

Move to CP0

Move from CP0

Branch on Coprocessor 0

This instruction generates a reserved opcode exception.

SYNC

CACHE

Interrupt and Exception Processing

Overview

This section describes the interrupt architecture of the XCaliber processor. Interrupts can be divided into three categories: MIPS-like interrupts, PMU interrupts and thread interrupts. In this section each of these interrupt categories is described, and it is shown how they are utilized with respect to software and the handling of CP0 registers.

MIPS-like interrupts in this example consist of eight interrupt sources: two software interrupts, one timer interrupt and five hardware interrupts. The two software interrupts are context specific and can be set and cleared by software, and only affect the context which has set or cleared them. The timer interrupt is controlled by the Count and Compare registers, is a global interrupt, and is delivered to at most one context. The five hardware interrupts come from the SIU in five separate signals. The SIU aggregates interrupts from over 20 sources into the five signals in a configurable way. The five hardware interrupts are level-triggered and must be cleared external to the SPU through the use of a write to SIU configuration space.

The thread interrupts consist of 16 individual interrupts, half of which are in the “All Respondents” category (that is, they will be delivered to all contexts that have them unmasked), and the other half which are in the “First Respondent” category (they will be delivered to at most one context).

The PMU interrupts consist of eight “Context Not Available” interrupts and five error interrupts. The Context Not Available interrupts are generated when the PMU has a packet to activate and there are no contexts available. This interrupt can be used to implement preemption or to implement interrupt driven manual activation of packets.

All first respondent interrupts have a routed bit associated with them. This bit, not visible to software, indicates if the interrupt has been delivered to a context. If a first respondent interrupt is present and unrouted, and no contexts have it unmasked, then it remains in the unrouted state until it either has been cleared or has been routed. While unrouted, an interrupt can be polled using global versions of the IP fields. When an interrupt is cleared, all IP bits associated with that interrupt and the routed bit are also cleared.

Instruction Set Instructions relevant to interrupt processing are just the MTC0 and MFC0 instructions. These instructions are used to manipulate the various IM and IP fields in the CP0 registers. The Global XIP register is used to deliver interrupts using the MTC0 instruction and the local XIP register is used to clear interrupts, also using the MTCO instruction. Global versions of the Cause and XIP registers are used to poll the global state of an interrupt.

The SIESTA instruction is also relevant in that threads which are in a siesta mode have a higher priority for being selected for interrupt response. If the count field of the siesta instruction is all 1's (0x7FFF), the context will wait until an interrupt with no cycle limit.

Interrupts do not automatically cause a memory system SYNC, the interrupt handler is responsible for performing one explicitly if needed.

The ERET instruction is used to return of an interrupt service routine.

Interrupt Processing

Threads may be interrupted by external events, including the PMU, and they may also generate thread interrupts which are sent to other threads. The extended XCaliber interrupts are vectored to 0x80000480 while BEV=0 and are disabled when BEV=1.

Interrupt Types

The XCaliber processor implements two types of interrupts: First Respondent and All Respondents. Every interrupt is defined to be one of these two types.

The First Respondent interrupt type means that only one of the contexts that have the specified interrupt unmasked will respond to the interrupt. If there are multiple contexts that have an interrupt unmasked, when that interrupt occurs, only one context will respond and the other contexts will ignore that interrupt.

The All Respondents interrupt type means that all of the contexts that have the specified interrupt unmasked will respond. In the case that a context is currently in a “siesta mode” due to the execution of a SIESTA instruction, an interrupt that is directed to that context will cause it to wake up and begin execution at the exception handling entry point. The EPC in that case is set to the address of the instruction following the SIESTA instruction.

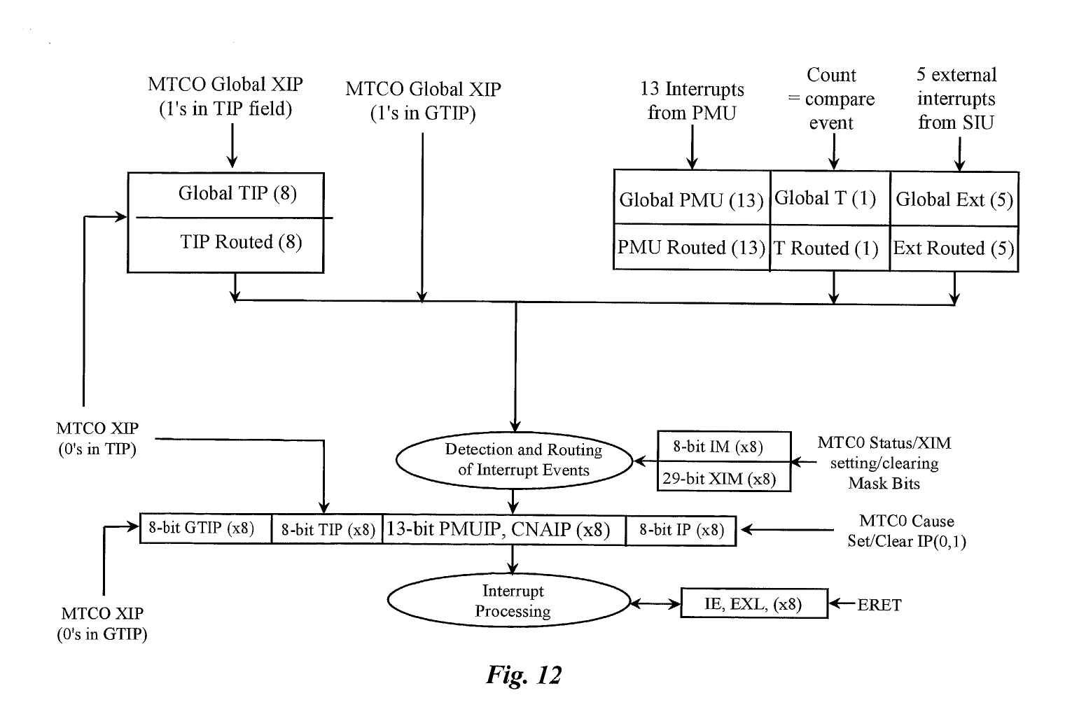

FIG. 12 is a chart of Interrupt control logic for the XCaliber DMS processor, helpful in following the descriptions provided herein. In general, interrupts are level triggered, which means that an interrupt condition will exist as long as the interrupt signal is asserted and the condition must be cleared external to the SPU.

When an interrupt condition is detected, interrupt control logic will determine which if any IP bits should be set based on the current settings of all of the IM bits for each context and whether the interrupt is a First Respondent or an All Respondents type of interrupt. Regardless of whether or not the context currently has interrupts disabled with the IE bit, the setting of the IP bits will be made. Once the IP bits are set for a given event, the interrupt is considered “routed” and they will not be set again until the interrupt is de-asserted and again asserted.

In the case of a First Respondents type of interrupt, the decision of which context should handle the interrupt is based on a number of criteria. Higher priority is given to contexts which are currently in a siesta mode. Medium priority is given to contexts that are not in a siesta mode, but have no loads pending and have EXL set to 0. Lowest priority is given to contexts that have EXL set to 1, or have a load pending.

All respondents interrupts are routed immediately and are never in an unrouted state.

External, Software and Timer Interrupts

There are five external interrupt along with two software interrupts and a timer interrupt. Each interrupt is masked with a bits in the IM field of the Status register (CP0 register 12). The external interrupts are masked with bits 2-6 of that field, the software interrupts with bits 0 and 1 and the timer interrupt with bit 7. There is one Status register for each CPU context, so each thread can mask each interrupt source individually. The external interrupt and the timer interrupt are defined to be First Respondent types of interrupts.

The two software interrupts are not shared across contexts but are local to the context that generated them. Software interrupts are not precise, so the interrupt may be taken several instructions after the instruction which writes to bits 8 or 9 of the CP0 Cause register.

Interrupt processing occurs at the same time as exception processing. If a context is selected to respond to an interrupt, all non-committed instructions for that context are invalidated and no further instructions are can be dispatched until the interrupt service routine. The context state will be changed to kernel mode, the exception level bit will be set, all further interrupts will be disabled and the PC will be set to entry point of the interrupt service routine.

Thread Interrupts

There are sixteen additional interrupts defined which are known as thread interrupts. These interrupts are used for inter-thread communication. Eight of these interrupts are defined to be of the First Respondent type and eight are defined to be of the All Respondents type. Fifteen of these sixteen interrupts are masked using bits in the Extended Interrupt Mask register. One of the All Respondent type of thread interrupts cannot be masked.

Any thread can raise any of the sixteen interrupts by setting the appropriate bit in the Global Extended Interrupt Pending register using the MTC0 instruction.

PMU Interrupts

The PMU can be configured to raise any of the eight Context Not Available interrupts on the basis of a configured default packet interrupt level, or based on a dynamic packet priority that is delivered by external circuitry. The purpose of PMU use of thread interrupts is to allow preemption so that a context can be released to be used by a thread associated with a packet with higher priority. The PMU interrupts, if unmasked on any context, will cause that context to execute interrupt service code which will save its state and release the context. The PMU will simply wait for a context to be released once it has generated the thread interrupt. As soon as any context is released, it will load its registers with packet information for the highest priority packet that is waiting. The PMU context will then be activated so that the SPU can run it.

When a thread is preempted, the context that is was running in is made available for processing another packet. In order for the preempted thread to be re-executed, the context release code must be written to handle thread resumption. When the workload for a packet has been completed, instead of releasing the context back to the PMU as it would normally do, the software can check for preempted threads and restore and resume one. The XIM register is reset appropriate to the thread that is being resumed.

In addition to the eight Context Not Available interrupts, there are five other special-purpose interrupts. These are mainly error conditions signaled by the PMU. Each of the 13 interrupts can be masked individually by each thread. When one of the 13 interrupts occurs, interrupt detection and routing logic will select one of the contexts that has the interrupt unmasked (i.e. the corresponding bit in the XIM register is set), and set the appropriate bit in that contexts XIP register. This may or may not cause the context to service that interrupt, depending on the state of the IE bit for that context. Since all PMU interrupts are level triggered, when the interrupt signal is deasserted, all IP bits associated with that interrupt will be cleared.

Summary of Interrupt Related CP0 Registers

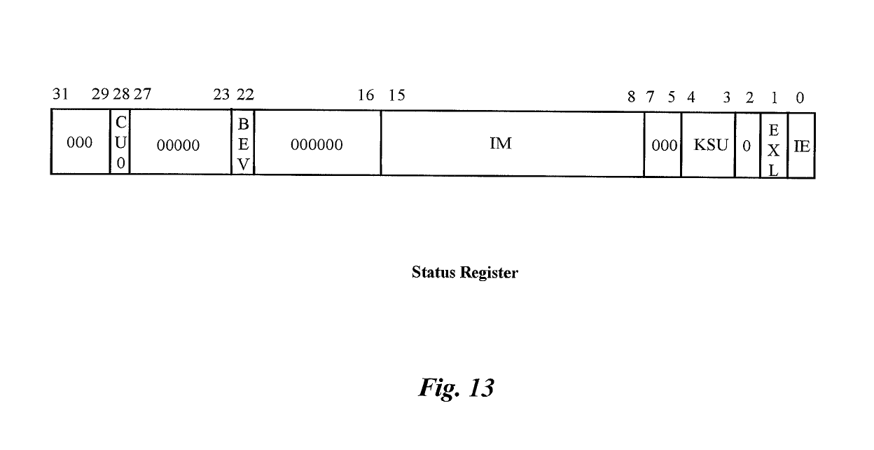

The Status register, illustrated in FIG. 13, is a MIPS-like register containing the eight bit IM field along with the IE bit, the EXL bit and the KSU field.

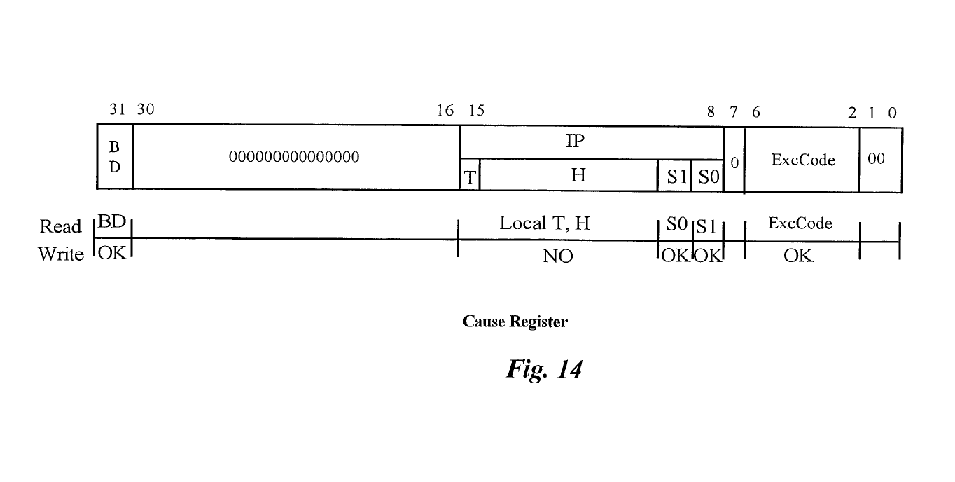

The Cause register, illustrated in FIG. 14, is a MIPS-like register containing the eight bit IP field along with the Exception code field, the CE field and the BD field. Only the IP field is relevant to interrupt processing.

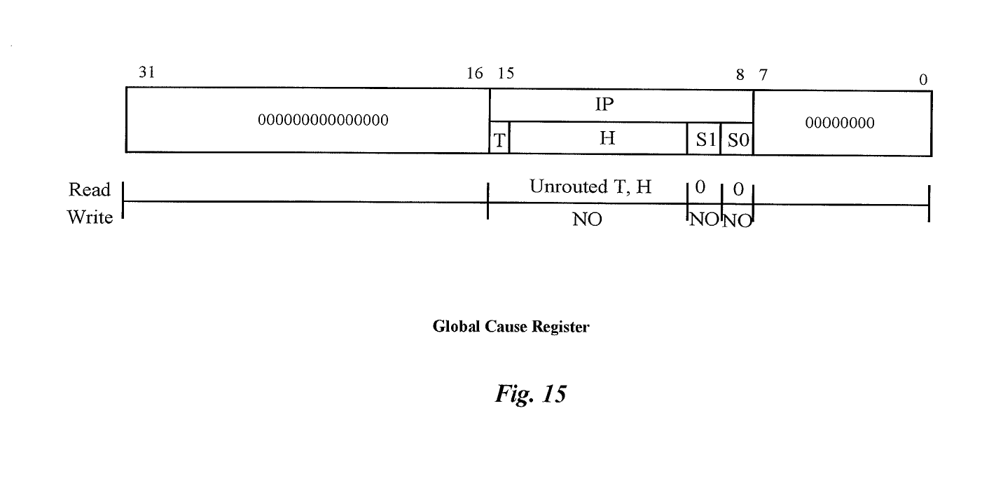

The Global Cause register, illustrated in FIG. 15, is analogous to the Cause register. It is used to read the contents of the global IP bits which represent un-routed interrupts.

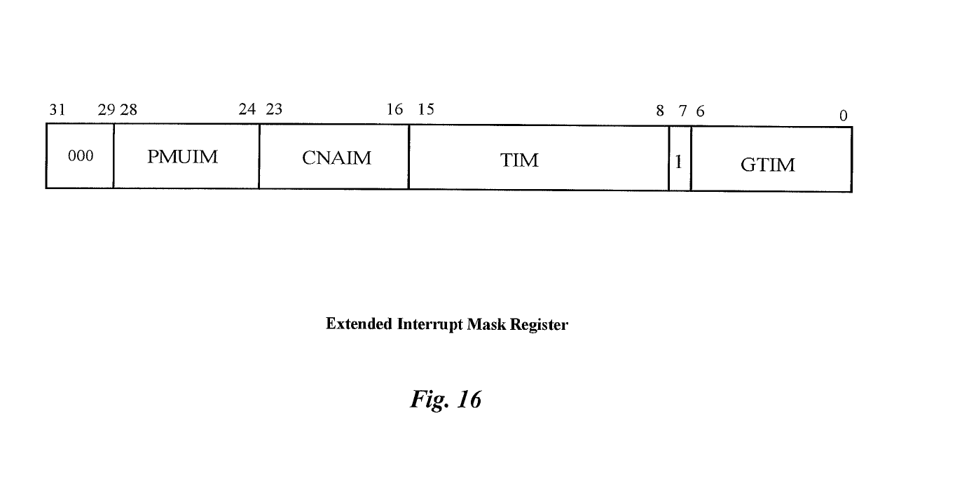

The Extended Interrupt Mask (XIM) register, illustrated in FIG. 16, is used to store the interrupt mask bits for each of the 13 PMU interrupts and the 16 thread interrupts.

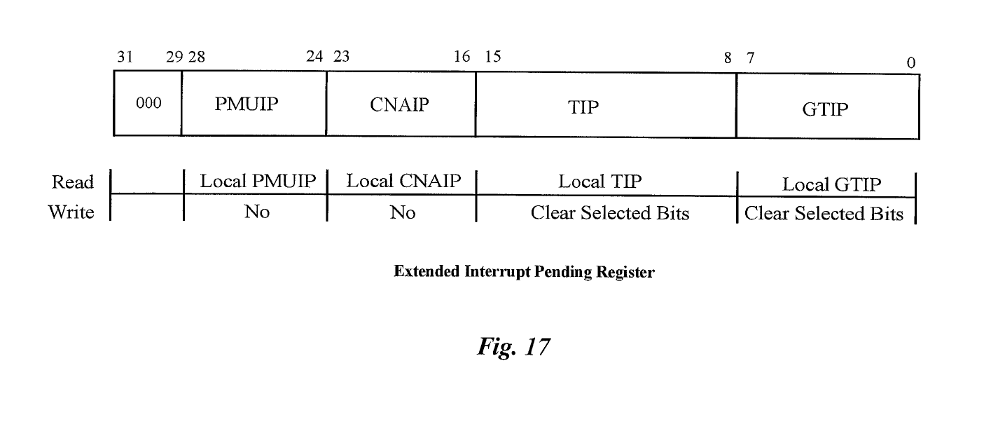

The Extended Interrupt Pending (XIP) register, illustrated in FIG. 17, is used to store the interrupt pending bits for each of the 14 PMU interrupts and the 16 thread interrupts.

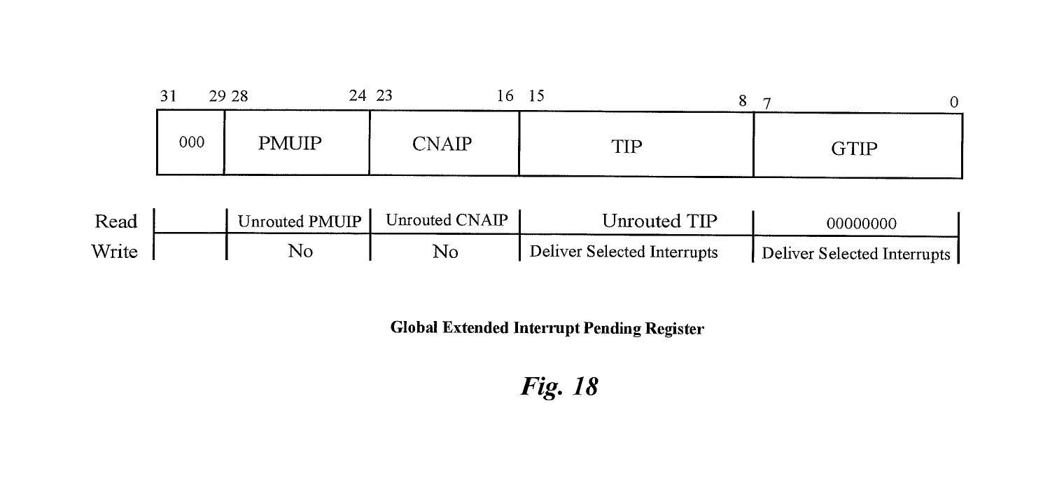

The Global Extended Interrupt Pending (GXIP) register, illustrated in FIG. 18, is used to store the interrupt pending bits for each of the 14 PMU interrupts and the 16 thread interrupts.

Other CP0 registers which are MIPS-like registers include the Count register (register 9) and the Compare register (register 11). These registers are used to implement a timer interrupt. In addition, the EPC register (register 14) is used to save the PC of the interrupted routine and are used by the ERET instruction.

PMU Interrupts

The SPU and the PMU within XCaliber communicate through the use of interrupts and commands that are exchanged between the two units. When a context is activated, all interrupt mask bits are 0, disabling all interrupts.

Overflow Started (XIM/XIP Bit 24)

The Overflow Started interrupt is used to indicate that a packet has started overflowing into external memory. This occurs when a packet arrives and it will not fit into internal packet memory. The overflow size register, a memory mapped register in the PMU configuration space, indicates the size of the packet which is overflowing or has overflowed. The SPU may read this register to assist in external packet memory management. The SPU must write a new value to the overflow pointer register, another memory mapped register in the PMU configuration space, in order to enable the next overflow. This means that there is a hardware interlock on this register such that after an overflow has occurred, until the SPU writes into this register a second overflow is not allowed. If the PMU receives a packet during this time that will not fit into internal packet memory, the packet will be dropped.

No More Pages (XIM/XIP Bit 25)

The No More Pages interrupt indicates that there are no more free pages within internal packet memory of a specific size. The SPU configures the PMU to generate this interrupt based on a certain page size by setting a register in the PMU configuration space.

Packet Dropped (XIM/XIP Bit 26)

The Packet Dropped interrupt indicates that the PMU was forced to discard an incoming packet. This generally occurs if there is no space in internal packet memory for the packet and the overflow mechanism is disabled. The PMU can be configured such that packets larger than a specific size will not be stored in the internal packet memory, even if there is space available to store them, causing them to be dropped if they cannot be overflowed. A packet will not be overflowed if the overflow mechanism is disabled or if the SPU has not readjusted the overflow pointer register since the last overflow. When a packet is dropped, no data is provided.

Number of Packet Entries Below Threshold (XIM/XIP Bit 27)

The Number of Packet Entries Below Threshold interrupt is generated by the PMU when there are fewer than a specific number of packet entries available. The SPU configures the PMU to generate this interrupt by setting the threshold value in a memory mapped register in PMU configuration space.

Packet Error (XIM/XIP Bit 28)

The Packet Error interrupt indicates that either a bus error or a packet size error has occurred. A packet size error happens when a packet was received by the PMU in which the actual packet size did not match the value specified in the first two bytes received. A bus error occurs when an external bus error was detected while receiving packet data through the network interface or while downloading packet data from external packet memory. When this interrupt is generated, a PMU register is loaded to indicate the exact error that occurred, the associated device ID along with other information. Consult the PMU Architecture Specification for more details.

Context Not Available (XIM/XIP Bits 16-23)

There are eight Context Not Available interrupts that can be generated by the PMU. This interrupt is used if a packet arrives and there are no free contexts available. This interrupt can be used to implement preemption of contexts. The number of the interrupt is mapped to the packet priority that may be provided by the ASIC, or predefined to a default number.

Thread Synchronization

This section describes the thread synchronization features of the XCaliber CPU. Because the XCaliber CPU implements parallelism at the instruction level across multiple threads simultaneously, software which depends on the relative execution of multiple threads must be designed from a multiprocessor standpoint. For example, when two threads need to modify the same data structure, the threads must synchronize so that the modifications take place in a coherent manner. This section describes how this takes place on the XCaliber CPU and what special considerations are necessary.

Thread Synchronization

An atomic memory modification is handled in MIPS using the Load Linked (LL, LLD) instruction followed by an operation on the contents, followed by a Store Conditional instruction (SC, SCD). For example, an atomic increment of a memory location is handled by the following sequence of instructions.

| | | |
|---|---|---|
| L1: | LL | T1, (T0) |
| | ADD | T2, T1, 1 |
| | SC | T2, (T0) |
| | BEQ | T2, 0, L1 |
| | NOP | |

Within the XCaliber processor, a stream executing a Load Linked instruction creates a lock of a that memory address, which is released on the next memory operation or other exceptional event. This means that multi-threaded code running within the XCaliber CPU will generate an actual hardware stall around an atomic read-modify-write sequence. This is an enhancement to the operation of normal MIPS multiprocessing code. It does not change the semantics of the LL or the SC instruction and code can be run without modifications.

The Store Conditional instruction will always succeed when the only contention is on-chip except in the rare cases of an interrupt taken between a LL and a SC or if the TLB entry for the location was replaced by another stream between the LL and the SC. If another stream tries to increment the same memory location using the same sequence of instructions, it will stall until the first stream completes the store. The above sequence of instructions is guaranteed to be atomic within a single XCaliber processor with respect to other streams. However, other streams are only locked out until the first memory operation after the LL or the first exception is generated. This means that software must not put any other memory instructions between the LL and the SC and no instructions which could generate an exception.

If an interrupt is taken on a stream that has set a lock but is not stalled itself, then the interrupt will be taken, any other streams that are stalled on that location will be released and the SC instruction will fail when the stream returns from the interrupt handler. If an interrupt is taken on a stream that is stalled on a lock, the stall condition will be cleared and the EPC (or ErrorPC) will point to the LL instruction so it will be re-executed when the interrupt handler returns.

The memory lock within the XCaliber CPU is accomplished through the use of one register which stores the physical memory address for each of the eight running streams. There is also a lock bit, which indicates that the memory address is locked, and a stall bit, which indicates that the associated stream is waiting for the execution of the LL instruction.

When a LL instruction is executed, the LL address register is updated and the Lock bit is set. In addition, a search of all other LL address registers is made in parallel with the access to the Data Cache. If there is a match with the associated Link bit set, this condition will cause the stream to stall and for the Stall bit to be set. When a Store Conditional instruction is executed, if the associated Lock bit is not set, it will fail and no store to the memory location will take place.

Whenever a Lock bit is cleared, the stall bit for any stream stalled on that memory address will be cleared which will allow the LL instruction to be completed. In this case the load instruction will be re-executed and its result will be placed in the register destination specified.

If multiple streams are waiting on the same address, the LL instructions will all be scheduled for re-execution when the Lock bit for the stream that is not stalled is cleared. If two LL instructions are dispatched in the same cycle, if the memory locations match, and if no LL address registers match, one will stall and the other will proceed. If a LL instruction and a SW instruction are dispatched in the same cycle to the same address, and assuming there is no stall condition, the LL instruction will get the old contents of the memory location, and the SW will overwrite the memory location with new data and the Lock bit will be cleared. Any store instruction from any stream will clear the Lock bit associated with a matching address.

Siesta Instruction

In a situation where a memory location just needs to updated atomically, for example to increment a counter as illustrated above, the entire operation can be implemented with a single LL/SC sequence. In that case the XCaliber CPU will stall a second thread wanting to increment the counter until the first thread has completed its store. This stall will be very short and no CPU cycles are wasted on reloading the counter if the SC fails.

In some cases the processor may need to busy wait, or spin-lock, on a memory location. For example, if an entry needs to be added to a table, multiple memory locations may need to be modified and updated in a coherent manner. This requires the use of the LL/SW sequence to implement a lock of the table. A busy wait on a semaphore would normally be implemented in a manner such as the following:

| | | |
|---|---|---|
| L1: | LL | T1, (T0) |
| | BNE | T1, 0, L1 |
| | ORI | T1, 0, 1 |
| | SC | T1, (T0) |
| | BEQ | T1, 0, L1 |
| | NOP | |

In this case the thread is busy waiting on the LL instruction until it succeeds with a read result which is zero (indicating the semaphore is unlocked). At that point a 1 is written to the memory location which locks the semaphore. Another stream executing this same code will busy wait, continually testing the memory location. A third stream executing this code would stall, since the second stream has locked the memory location containing the semaphore. The unlock operation can be implemented with a simple store of 0 to the target address as follows:

| | | |
|---|---|---|
| U1: | SW | 0, (T0) |

In a busy wait situation such as this, rather than wasting CPU cycles repeatedly testing a memory location (for the second stream), or stalling a stream entirely (for the third and subsequent streams), it may be more efficient to stall the context explicitly.

o increase CPU efficiency in these circumstances, a SIESTA instruction is provided to allow the programmer and should be used in cases where the wait for a memory location is expected to be longer than a few instructions. The example shown above could be re-written in the following way:

| | |
|---|---|
| L1: | LL T1, (T0) |
| BEQ | T1, 0, L2 |
| ORI | T1, 0, 1 |
| SIESTA | 100 |
| J | L1 |
| NOP | |
| L2: | SC T1, (T0) |
| BEQ | T1, 0, L1 |
| NOP | |

The SIESTA instruction takes one argument which is the number of cycles to wait. The stream will wait for that period of time and then become ready when it will then again become a candidate for dispatch. If an interrupt occurs during a siesta, the sleeping thread will service the interrupt with its EPC set to the instruction after the SIESTA instruction. A SIESTA instruction may not be placed in the delay slot of a branch. If the count field is set to all 1's (0x7FFF), then there is no cycle count and the context will wait until interrupted. Note that since one of the global thread interrupts is not maskable, a context waiting in this mode can always be recovered through this mechanism.

Note that the execution of a SIESTA instruction will clear the Lock bit for that stream. This will allow other streams that are stalled on the same memory location to proceed (and also execute SIESTA instructions if the semaphore is still not available).

y forcing a stall, the SIESTA instruction allows other contexts to get useful work done. In cases that the busy wait is expected to be very long, on the order of 1000s of instructions, it would be best to self-preempt. This can be accomplished through the use of a system call or a software interrupt. The exception handling code would then save the context state and release the context. External timer interrupt code would then decide when the thread becomes runnable.

Multi-processor Considerations

n an environment in which multiple XCaliber CPUs are running together from shared memory, the usual LL/SC thread synchronization mechanisms work in the same way from the standpoint of the software. The memory locations which are the targets of LL and SC instructions must be in pages that are configured as shared and coherent, but not exclusive. When the SC instruction is executed, it sends an invalidation signal to other caches in the system. This will cause SC instructions on any other CPU to fail. Coherent cache invalidation occurs on a cache line basis, not on a word basis, so it is possible for a SC instruction to fail on one processor when the memory location was not in fact modified, but only a nearby location was modified by another processor.

Initialization State

Reset State

When the XCaliber processor is reset, the following data structures are initialized according to the table shown below. Upon reset, only a single context is running, context 0, and all other contexts are stalled. The fetch PCs are invalid for contexts 1-7, so no fetching will take place, and the instruction queues are cleared, so no dispatching will take place. Contexts 1-7 will start up under two circumstances: the execution of a “Get Context” instruction, or the arrival of a packet.

Global Resources

1. Instruction Cache

| | |
|---|---|
| Data | don't care |
| Tags | |

| | |
|---|---|
| PC tag | don't care |

| | |
|---|---|
| Vbit | don't care |

| | |
|---|---|
| LRU Table | don't care |
| Lock bits | don't care |

2. Instruction Queues

| | |
|---|---|
| Data | don't care |
| Tags | |

| | |
|---|---|
| PC tag | don't care |

| | |
|---|---|
| Vbit | all bits 0 |

| | |
|---|---|
| Pointers | write = read = 0 |

| | |
|---|---|
| 3. Target Address Register | don't care |

| | |
|---|---|
| 4. TLBs | don't care |
| 5. Global CP0 Registers | |

MMU

| | |
|---|---|
| Index | don't care |
| Random | don't care |
| EntryLo0 | don't care |
| EntryLo1 | don't care |
| PageMask | don't care |
| Wired | don't care |

Interrupt

| | |
|---|---|
| Count | don't care |
| Compare | don't care |

Misc

| | |
|---|---|
| PRId | n/a (not a real register) |

| | |
|---|---|
| Config | ??? |

| | |
|---|---|
| 6. Load Store Queues | (empty) |
| 7. Data Cache | |

| | |
|---|---|
| Data | don't care |
| Tags | |

| | |
|---|---|
| PC tag | don't care |

| | |
|---|---|
| D bit | don't care |
| V bit | don't care |

| | |
|---|---|
| LRU data | don't care |
| Lock bits | don't care |

| | |
|---|---|
| 8. PM Write Buffers | (empty) |

Context 0 Resources

| | |
|---|---|
| 1. Register Files | all 0 |

| | |
|---|---|
| 2. HI/LO Registers | all 0 |
| 3. PCs | |

| | |
|---|---|
| Fetch PC | 0×FFFFFFF0 |

| | |
|---|---|
| Fetch PC Active Bit | 1 |

| | |
|---|---|
| Commit PC | 0×FFFFFFF0 |

4. CP0 Registers

MMU

| | |
|---|---|
| Context | don't care |
| Bad VAddr | don't care |
| EntryHi | don't care |

Interrupt

Status

BEV=1,KSU=00,IE=0,IM=0,ERL=0,EXL=0

Cause

BD=0,IP=0,ExcCode=0

| | |
|---|---|
| EPC | don't care |
| ErrorPC | don't care |
| XIM | 0 |
| XIP | 0 |

Misc

| | |
|---|---|
| Context Number | n/a (not a real register) |

Context 1-7 Resources

| | | |
|---|---|---|
| 1. | Register Files | don't care |
| 2. | HI/LO Registers | don't care |
| 3. | PCs | |
| | Fetch PC | don't care |
| | Fetch PC Active Bit | 0 |
| | Commit PC | don't care |
| 4. | CP0 Registers | |
| | MMU | |
| | Context | don't care |
| | Bad VAddr | don't care |
| | EntryHi | don't care |
| | Interrupt | |
| | Status | don't care |
| | Cause | don't care |
| | EPC | don't care |
| | ErrorPC | don't care |
| | XIM | don't care |
| | XIP | don't care |
| | Misc | |
| | Context Number | n/a (not a real register) |

Context Activation State

When a context is activated (in response to a packet arrival or a GETCTX instruction), the following data structures are initialized as follows.

| | | |
|---|---|---|
| 1. | Register File | all 0 |
| 2. | HI/LI Registers | all 0 |
| 3. | PCs | |
| | Fetch PC | 0 × 80000400 (or |
| | | operand of GETCTX) |
| | Commit PC | 0 × 80000400 (or |
| | | operand of GETCTX) |
| 4. | CPO Registers | |
| | MMU | |
| | Context | don't care |
| | Bad VAddr | don't care |
| | EntryHi | ASID = 0 |
| | Interrupt | |
| | Status | |

| BEV = 0, KSU = 00, IE = 0, | |
|---|---|
| IM = 0, ERL = 0, EXL = 0 | |
| Cause | BD = 0, IP = 0 |
| EPC | don't care |
| ErrorPC | don't care |
| XIM | 0 |
| XIP | 0 |
| Misc | |
| Context Number | n/a (not a real register) |

SPU/PMU Communication

The SPU and the PMU within XCaliber communicate through the use of interrupts and commands that are exchanged between the two units. Additionally, contexts are passed back and forth between the PMU and SPU through the mechanism of context activation (PMU to SPU) and context release (SPU to PMU). The PMU is configured through a 4K byte block of memory-mapped registers. The location in physical address space of the 4K block is controlled through the SIU address space mapping registers.

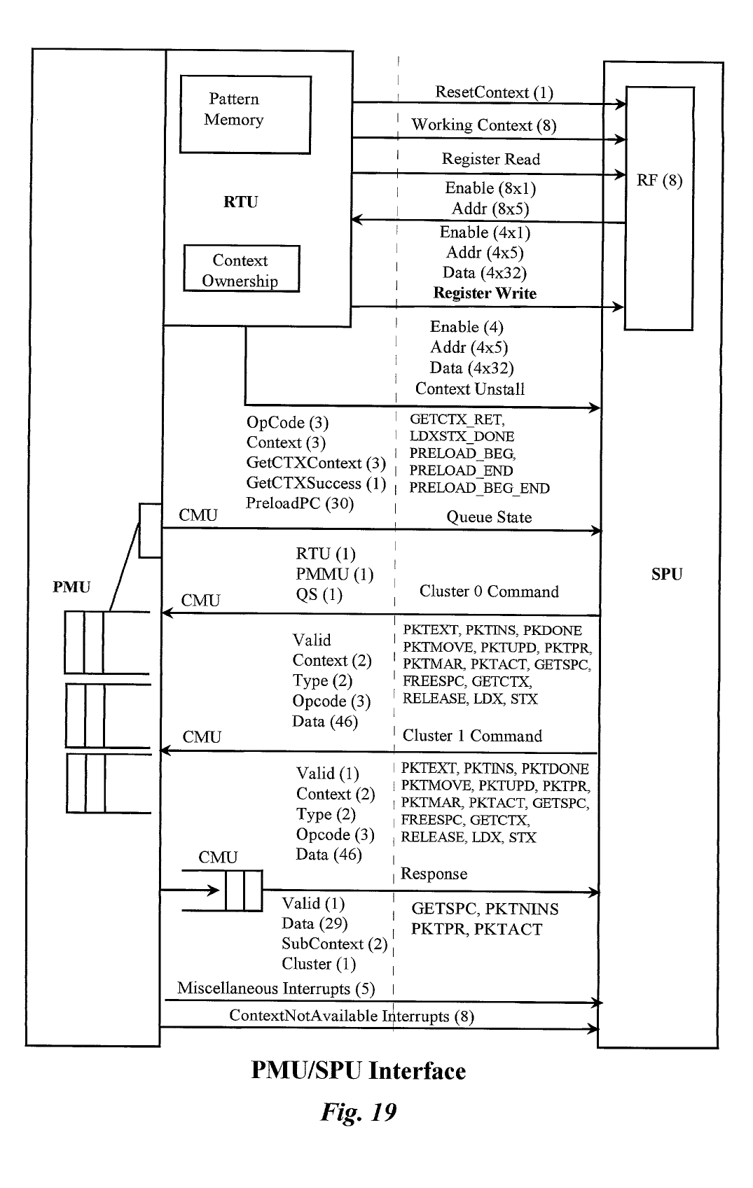

FIG. 19 is a diagram of the communication interface between the SPU and the PMU, and is helpful for reference in understanding the descriptions that follow.

Context Activation

There are eight contexts within the XCaliber CPU. A context refers to the thread specific state that is present in the processor, which includes a program counter, general purpose and special purpose registers. Each context is either SPU owned or PMU owned. When a context is PMU owned it is under the control of the PMU and is not running a thread.

Context activation is the process that takes place when a thread is transferred from the PMU to the SPU. The PMU will activate a context when a packet arrives and there are PMU owned contexts available. The local registers for a context are initialized in a specific way before activation takes place. There are packet-specific registers that are preloaded with packet data in a configurable way, and there are other registers that are initialized. The SPU may also explicitly request that a context be made available so that a non-packet related thread can be started.

The preloaded registers are the mask that is used to define them are described in the RTU section of the PMU document. The GPRs that are not pre-loaded by the mask are undefined. The program counter is initialized to 0x80000400. The HI and LO registers are undefined and the context specific CP0 registers are initialized as follows:

| | |
|---|---|
| Context (4) | undefined |
| Stream(7) | not applicable (not a real register, returns the |
| | context number) |
| BadVAddr(8) | undefined |
| EntryHi(10) | VPN2 is undefined, ASID = 0 |
| Status(12) | 0 × 000000000 (kernel mode, interrupts |
| | disabled) |
| Cause(13) | 0 × 000000000 (BD = 0, IP = 0) |
| XIM(23) | 0 × 00000000 (all interrupts masked) |
| XIP(24) | 0 × 00000000 (no interrupts pending) |

PMU Interrupts

(1) Overflow Started (XIM/XIP Bit 16)

The Overflow Started interrupt is used to indicate that a packet has started overflowing into external memory. This occurs when a packet arrives and it will not fit into internal packet memory. The overflow size register, a memory mapped register in the PMU configuration space, indicates the size of the packet which is overflowing or has overflowed. The SPU may read this register to assist in external packet memory management. The SPU must write a new value to the overflow pointer register, another memory mapped register in the PMU configuration space, in order to enable the next overflow. This means that there is a hardware interlock on this register such that after an overflow has occurred, until the SPU writes into this register a second overflow is not allowed. If the PMU receives a packet during this time that will not fit into internal packet memory, the packet will be dropped.

(2) No More Pages (XIM/XIP Bit 17)

The No More Pages interrupt indicates that there are no more free pages within internal packet memory of a specific size. The SPU configures the PMU to generate this interrupt based on a certain page size by setting a register in the PMU configuration space.

(3) Packet Dropped (XIM/XIP Bit 18)

The Packet Dropped interrupt indicates that the PMU was forced to discard an incoming packet. This generally occurs if there is no space in internal packet memory for the packet and the overflow mechanism is disabled. The PMU can be configured such that packets larger than a specific size will not be stored in the internal packet memory, even if there is space available to store them, causing them to be dropped if they cannot be overflowed. A packet will not be overflowed if the overflow mechanism is disabled or if the SPU has not readjusted the overflow pointer register since the last overflow. When a packet is dropped, no data is provided.

(4) Number of Packet Entries Below Threshold (XIM/XIP Bit 19)

The Number of Packet Entries Below Threshold interrupt is generated by the PMU when there are fewer than a specific number of packet entries available. The SPU configures the PMU to generate this interrupt by setting the threshold value in a memory mapped register in PMU configuration space.

(5) Packet Error (XIM/XIP Bit 20)

The Packet Error interrupt indicates that either a bus error or a packet size error has occurred. A packet size error happens when a packet was received by the PMU in which the actual packet size did not match the value specified in the first two bytes received. A bus error occurs when an external bus error was detected while receiving packet data through the network interface or while downloading packet data from external packet memory. When this interrupt is generated, a PMU register is loaded to indicate the exact error that occurred, the associated device ID along with other information. Consult the PMU Architecture Specification for more details.

(6) Context Not Available (XIM/XIP Bits 8-15)

There are eight Context Not Available interrupts that can be generated by the PMU. This interrupt is used if a packet arrives and there are no free contexts available. This interrupt can be used to implement preemption of contexts. The number of the interrupt is mapped to the packet priority that may be provided by the ASIC, or predefined to a default number.

PMU Instructions

There are at least ten instructions which are provided for communication with the PMU. The format of these instructions is detailed above in the Instruction Set section. These ten instructions can be divided into three categories: two packet memory instructions (GETSPC and FREESPC), eight packet queue instructions (PKTEXT, PKTINS, PKTDONE, PKTMOVE, PKTMAR, PKTACT, PKTUPD and PKTPR) and two RTU instructions (RELEASE and GETCTX). Each of these three categories has its own command queue within the PMU. The PMU architecture document describes the format of these command queues. Of these twelve instructions, seven execute silently (i.e. they are sent to the PMU and there is no response and execution continues in the context which executed them), and five have a return value. For the five that have a return value (GETSPC, PKTINS, PKTACT, PKTPR and GETCTX), only one may be outstanding at any given time for each context. Thus, if a response has not been received for a given instruction, no more instructions requiring a response can be dispatched until the response is received.

Several PMU instructions operate on packet numbers. A packet number is an 8-bit number which is the internal index of a packet in the PMU. A packet has also associated with it a packet page, which is a 16-bit number which is the location in packet memory of the packet, shifted by 8 bits.

(1) Get Space Instruction

Assembly Language Format:

GETSPCrd, rs

The source register, rs, contains the size of the memory piece being requested in bytes. Up to 64K bytes of memory may be requested and the upper 16-bits of the source register must be zero. The destination register, rd, contains the packet memory address of the piece of memory space requested and an indication of whether or not the command was successful. The least significant bit of the destination register will be set to 1 if the operation succeeded and the 256-byte aligned 24-bit packet memory address will be stored in the remainder of the destination register. The destination register will be zero in the case that the operation failed. The destination register can be used as a packet ID as-is in most cases, since the lower 8 bits of packet ID source registers are ignored. In order to use the destination register as a virtual address to the allocated memory, the least significant bit must be cleared, and the most significant byte must be replaced with the virtual address offset of the 16Mb packet memory space.

(2) Free Space Instruction

Assembly Language Format:

FREESPC rs

The source register, rs, contains the packet page number, or the 24-bit packet memory address, of the piece of packet memory that is being released. This instruction should only be issued for a packet or a piece of memory that was previously allocated by the PMU, either upon packet arrival or through the use of a “Get Space” instruction. The lower eight bits and the upper eight bits of the source register are ignored. If the memory was not previously allocated by the PMU, the command will be ignored by the PMU. The size of the memory allocated is maintained by the PMU and is not provided by the SPU. Once this command is queued, the context that executed it is not stalled and continues, there is no result returned. A context which wishes to drop a packet must issue this instruction in addition to the “Packet Extract” instruction described below.

(3) Packet Insert Instruction

Assembly Language Format:

PKTINS rd, rs, rt

The first source register, rs, contains the packet page number of the packet which is being inserted. The second source register, rt, contains the queue number into which the packet should be inserted. The destination register, rd, is updated according to whether or not the operation succeeded or failed. The packet page number must be the memory address of a region which was previously allocated by the PMU, either upon a packet arrival or through the use of a “Get Space” instruction. The least significant five bits of rt contain the destination queue number for the packet and bits 6-31 must be zero. The PMU will be unable to complete this instruction if there are already 256 packets stored in the queuing system. In that case, a 1 is returned in the destination register, otherwise the packet number is returned.

(4) Packet Extract Instruction

Assembly Language Format:

PKTEXT rs

The source register, rs, contains the packet number of the packet which is being extracted. The packet number must be the 8-bit index of a packet which was previously inserted into the PMU queuing system, either automatically upon packet arrival or through a “Packet Insert” instruction. This instruction does not de-allocate the packet memory occupied by the packet, but removes it from the queuing system. A context which wishes to drop a packet must issue this instruction in addition to the “Free Space” instruction described above. The MSB of the source register contains a bit which if set causes the extract to only take place if the packet is not currently “active”. An active packet means one that has been sent to the SPU but has not yet been extracted or completed. The “Extract if not Active” instruction is intended to be used by software to drop a packet that was probed in order to avoid the race condition that it was activated after being probed.

(5) Packet Move Instruction

Assembly Language Format:

PKTMOVE rs, rt

The first source register, rs, contains the packet number of the packet which should be moved. The second source register, rt, contains the new queue number for the packet. The packet number must be the 8-bit number of a packet which was previously inserted into the PMU queuing system, either automatically upon packet arrival or through a “Packet Insert” instruction. This instruction updates the queue number associated with a packet. It is typically used to move a packet from an input queue to an output queue. All packet movements within a queue take place in order. This means that after this instruction is issued and completed by the PMU, the packet is not actually moved to the output queue until it is at the head of the queue that it is currently in. Only a single Packet Move or Packet Move And Reactivate (see below) instruction may be issued for a given packet activation. There is no return result from this instruction.

(6) Packet Move And Reactivate Instruction

Assembly Language Format:

PKTMAR rs, rt

The first source register, rs, contains the packet number of the packet which should be moved. The second source register, rt, contains the new queue number for the packet. The packet number must be the 8-bit number of a packet which was previously inserted into the PMU queuing system, either automatically upon packet arrival or through a “Packet Insert” instruction. This instruction updates the queue number associated with a packet. In addition, it marks the packet as available for re-activation. In this sense it is similar to a “Packet Complete” instruction in that after issuing this instruction, the stream should make no other references to the packet. This instruction would typically used after software classification to move a packet from the global input queue to a post-classification input queue. All packet movements within a queue take place in order. This means that after this instruction is issued and completed by the PMU, the packet is not actually moved to the destination queue until it is at the head of the queue that it is currently in. Only a single Packet Move or Packet Move And Reactivate instruction may be issued for a given packet activation. There is no return result from this instruction.

(7) Packet Update Instruction

Assembly Language Format:

PKTUPD rs, rt

The first source register, rs, contains the old packet number of the packet which should be updated. The second source register, rt, contains the new packet page number. The old packet number must be a valid packet which is currently queued by the PMU and the new packet page number must be a valid memory address for packet memory. This instruction is used to replace the contents of a packet within the queuing system with new contents without losing its order within the queuing system. Software must free the space allocated to the old packet and must have previously allocated the space pointed to by the new packet page number.

(8) Packet Done Instruction

Assembly Language Format:

PKTDONE rs, rt

The first source register, rs, contains the packet number of the packet which has been completed. The second source register, rt, contains the change in the starting offset of the packet and the transmission control field. The packet number must be the number of a packet which is currently in the queuing system. This instruction indicates to the PMU that the packet is ready to be transmitted and the stream which issues this instruction must not make any references to the packet after this instruction. The rt register contains the change in the starting point of the packet since the packet was originally inserted into packet memory. If rt is zero, the starting point of the packet is assumed to be the value of the HeaderGrowthOffset register. The maximum header growth offset is 511 and the largest negative value allowed is the value of the HeaderGrowthOffset, which ranges from 0 to 224 bytes. The transmission control field specifies what actions should be taken in connection with sending the packet out. Currently there are three sub-fields defined: device ID, CRC operation and deallocation control.

(9) Packet Probe Instruction

Assembly Language Format:

PKTPR rt, rs, item

The source register, rs, contains the packet number or the queue number which should be probed and an activation control bit. The target register, rt, contains the result of the probe. The item number indicates the type of the probe, a packet probe or a queue probe. This instruction obtains information from the PMU on the state of a given packet, or on a given queue. When the value of item is 0, the source register contains a packet number, when the value of item is 1, the source register contains a 5-bit queue number. A packet probe returns the current queue number, the destination queue number, the packet page number and the state of the following bits: complete, active, re-activate, allow activation. In the case that the activation control bit is set, the allow activation bit is set and the probe returns the previous value of the allow activation bit. A queue probe returns the size of the given queue.

(10) Packet Activate Instruction

Assembly Language Format:

PKTACT rd, rs

The source register, rs, contains the packet number of the packet that should be activated. The destination register, rd, contains the location of the success or failure indication. If the operation was successful, a 1 is placed in rd, otherwise a 0 is placed in rd. This command will fail if the packet being activated is already active, or if the allow activation bit is not set for that packet. This instruction can be used by software to get control of a packet that was not preloaded and activated in the usual way. One use of this function would be in a garbage collection routine in which old packets are discarded. The Packet Probe instruction can be used to collect information about packets, those packets can then be activated with this instruction, followed by a Packet Extract and a Free Space instruction. If a packet being dropped in this way is activated between the time it was probed and the Packet Activate instruction, the command will fail. This is needed to prevent a race condition such that a packet being operated on is dropped. There is an additional hazard due to a possible “reincarnation” of a different packet with the same packet number and the same packet page number. To handle this, the garbage collection routine must use the activation control bit of the probe instruction which will cause the Packet Activate instruction to fail if the packet has not been probed.

(11) Get Context Instruction

Assembly Language Format:

GETCTX rd, rs

The source register, rs, contains the starting PC of the new context. The destination register, rd, contains the indication of success or failure. Below is sample code to illustrate the use of the Get Context instruction.

| | | |
|---|---|---|
| | jal | fork |
| | | flop |
| child: | | |
| ;do child processing | | |
| ; | | |
| | release | |
| fork: | getctx | $11, $31 |
| | beqz | $11, fork |
| | nop | |
| parent: | | |
| ;do parent processing | | |
| ; | | |
| release | | |

(12) Release Instruction

Assembly Language Format:

RELEASE

This instruction has no operands. It releases the current context so that it become available to the PMU for loading a new packet.

SPU/SIU Communication

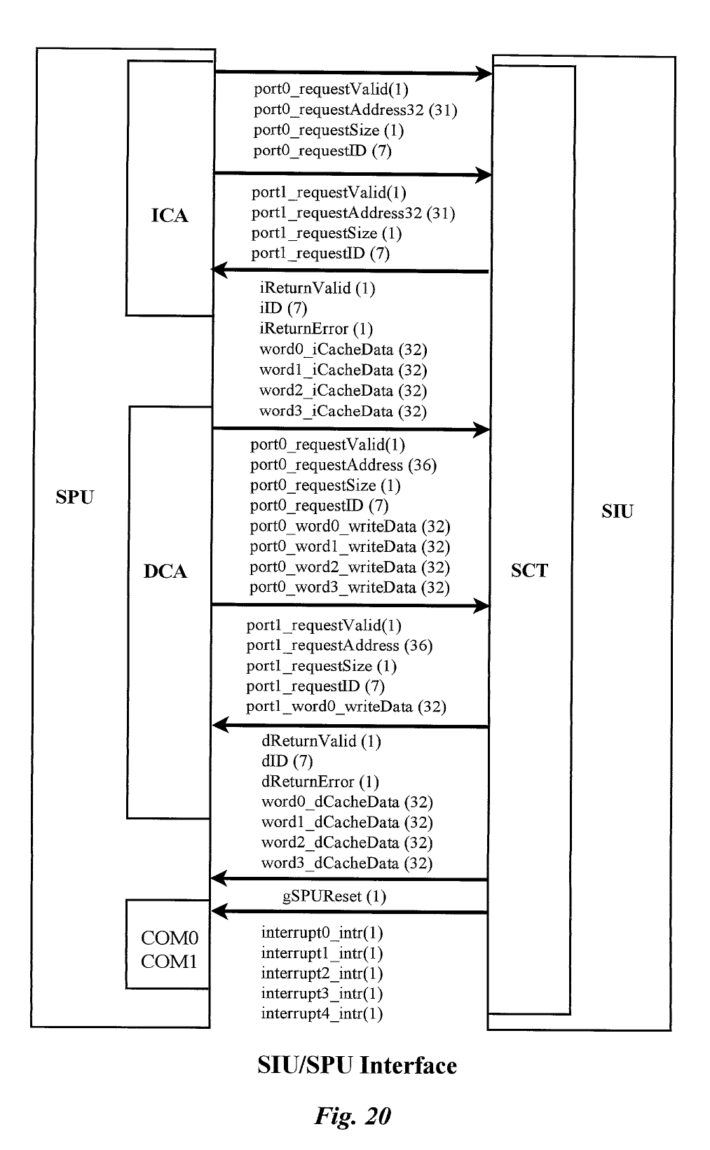

The SPU and the SPU within XCaliber communicate through the use of command and data buses between the two blocks. There are two command ports which communicate requests to the SIU, one associated with the Data Cache and one associated with the Instruction Cache. There are also two return ports which communicate data from the SIU, one associated with the Instruction Cache and one associated with the Data Cache. There is one additional command port which is used to communicate coherency messages from the SIU to the Data Cache. The SIU is configured through a block of memory-mapped registers. The location in physical address space of the block is fixed. FIG. 20 is a diagram of the SIU to SPU Interface for reference with the descriptions herein. Further, the table immediately below illustrates specific intercommunication events between the SIU and the SPU:

| From | To | Name | Bits | Description |
|---|---|---|---|---|
| SPU | SIU | IRequestValid | 1 | The SPU is providing a valid request on the request |
| | | | | bus. |
| | | IRequestAddress | 36 | The physical address of the data being read or written. |
| | | IRequest Size | 3 | The size of the data being read or written: |
| | | | | 0-1: (reserved) |
| | | | | 2:4 bytes |
| | | | | 3: (reserved) |
| | | | | 4:64 bytes |
| | | | | 5-7: (reserved) |
| | | IRequestID | 5 | A unique identifier for the request. The SPU is |
| | | | | responsible for generating request ID and guaranteeing |
| | | | | that they are unique. |
| | | IRequestType | 3 | The type of request being made: |
| | | | | 0: Instruction Cache Read |
| | | | | 1-3: (reserved) |
| | | | | 4: Uncached Instruction Read |
| | | | | 5-7: (reserved) |
| SIU | SPU | IGrant | 1 | The request has been accepted by the SIU. The SPU |
| | | | | must continually assert the request until this signal is |
| | | | | asserted. In the case of writes that require multiple |
| | | | | cycles to transmit, the remaining data is delivered in |
| | | | | successive cycles. |
| SIU | SPU | IReturnValid | 1 | The SIU is delivering valid instruction read data |
| | | IReturnData | 128 | Return data from an instruction read request. This is |
| | | | | one fourth of an instruction cache line and the |
| | | | | remaining data is delivered in successive cycles. In the |
| | | | | case of an uncached instruction read, the size is always |
| | | | | 4 bytes and is delivered in the least significant 32-bits |
| | | | | of this field. |
| | | IReturnID | 5 | The ID associated with the instruction read request. |
| | | IReturnType | 3 | The type associated with the instruction read request. |
| | | | | This should always be 0 or 4. |
| SPU | SIU | DRequestValid | 1 | The SPU is providing a valid request on the request bus. |
| | | DRequestAddress | 36 | The physical address of the data being read or written. |
| | | DRequestSize | 3 | The size of the data being read or written: |
| | | | | 0:1 byte |
| | | | | 1:2 bytes |
| | | | | 2:4 bytes |
| | | | | 3: (reserved) |
| | | | | 4:64 bytes |
| | | | | 5-7: (reserved) |
| | | DRequest ID | 5 | A unique identifier for the request. The SPU is responsible for |
| | | | | generating request ID and guaranteeing that they are unique. |
| | | DRequestType | 3 | The type of request being made: |
| | | | | 0: (reserved) |
| | | | | 1: Data Cache Read - Shared |
| | | | | 2: Data Cache Read - Exclusive |
| | | | | 3: Data Cache Write |
| | | | | 4: (reserved) |
| | | | | 5: Uncached Data Read |
| | | | | 6: Uncached Data Write |
| | | | | 7: (reserved) |
| | | DRequestData | 128 | The data associated with the request in the case of a write. In the |
| | | | | case of a Data Cache Write, if the size is greater than 128 bits, the |
| | | | | remaining portion of the data is provided in successive cycles once |
| | | | | the request has been accepted. |
| SIU | SPU | DGrant | 1 | The request has been accepted by the SIU. The SPU must |
| | | | | continually assert the request until this signal is asserted. In the case |
| | | | | of writes that require multiple cycles to transmit, the remaining data |
| | | | | is delivered in successive cycles. |
| SIU | SPU | DReturnValid | 1 | The SIU is providing valid return data. |
| | | DReturnData | 128 | Return data from any request other than an instruction read request. |
| | | | | In the case that the size of the request is larger than 16 bytes, the |
| | | | | remaining data is returned in successive cycles once the delivery of |
| | | | | the data has been accepted.. |
| | | DReturnID | 5 | The transaction ID associated with the data read request. |
| | | DReturnType | 3 | The type associated with the data request This should always be 1,2 |
| | | | | or 5. |
| SPU | SIU | DAccept | 1 | The SPU has accepted the return data. The SIU must continually |
| | | | | assert the data return until it has been accepted by the SPU. In the |
| | | | | case of results that require multiple cycles to transmit the remaining |
| | | | | data is delivered in successive cycles. |
| SIU | SPU | CValid | 1 | The SIU is providing a valid coherency command. |
| | | CAddress | 36 | The physical address associated with the coherency command. |
| | | CCommand | 2 | The coherency command being sent: |
| | | | | 0: Invalidate |
| | | | | 1-3: (reserved) |
| SPU | SIU | CDone | 1 | The coherency command has been completed. |

Performance Monitoring and Debugging

Event Counting

A number of different events within the SPU block are monitored and can be counted by performance counters. A total of eight counters are provided which may be configured dynamically to count all of the events which are monitored. The table below indicates the events that are monitored and the data associated with each event.

| Event | Data Monitored/Counted |
|---|---|
| Context Selected for | Context Number |
| Fetch | Straight Line, Branch, SIU Return |
| Instruction Cache Event | Hit, Miss |
| Data Cache Event | Load Hit, Load Miss, |
| | Store Hit, Store Miss, |
| | Dirty Write-back |
| Instruction Queue Event | Number of Instructions Written |
| | Context Number |
| | Number of Valid Instructions in Queue |
| Dispatch Event | Number of Instructions Dispatched |
| | Context Number for each Instruction |
| | Number Available for each Stream |
| | Number of RF Read Ports Used |
| | Number of Operands Bypassed |
| Execute Event | Context Numbers |
| | Type of Instructions Executed |
| Exception Taken | Context Number |
| | Type of Exception |
| | TLB Exception |
| | Address Error Exception |
| | Integer Overflow |
| | Syscall, Break, Trap |
| Interrupt Taken | Context Number |
| | Type of Interrupt |
| | Thread Interrupt |
| | PMU Interrupt |
| | External, Timer, Software Interrupt |
| Commit Event | Context Numbers |
| | Number of Instructions Committed |
| | Number of RF Write Ports Used |
| Branch Event | Context Numbers |
| | Branch Taken |
| | Stage of Pipeline Containing Target |
| | Branch Not Taken |
| Stall Event | Context Numbers |
| | Type of Stall |
| | LDX, STX, PMIU Stall |
| | Multiply, Divide Stall |
| | Load Dependency Stall |
| | Instruction Cache Miss Stall |
| | Load Linked Stall |
| | LSU Queue Full Stall |
| Load Store Unit Event | Size of Load Store Queue |

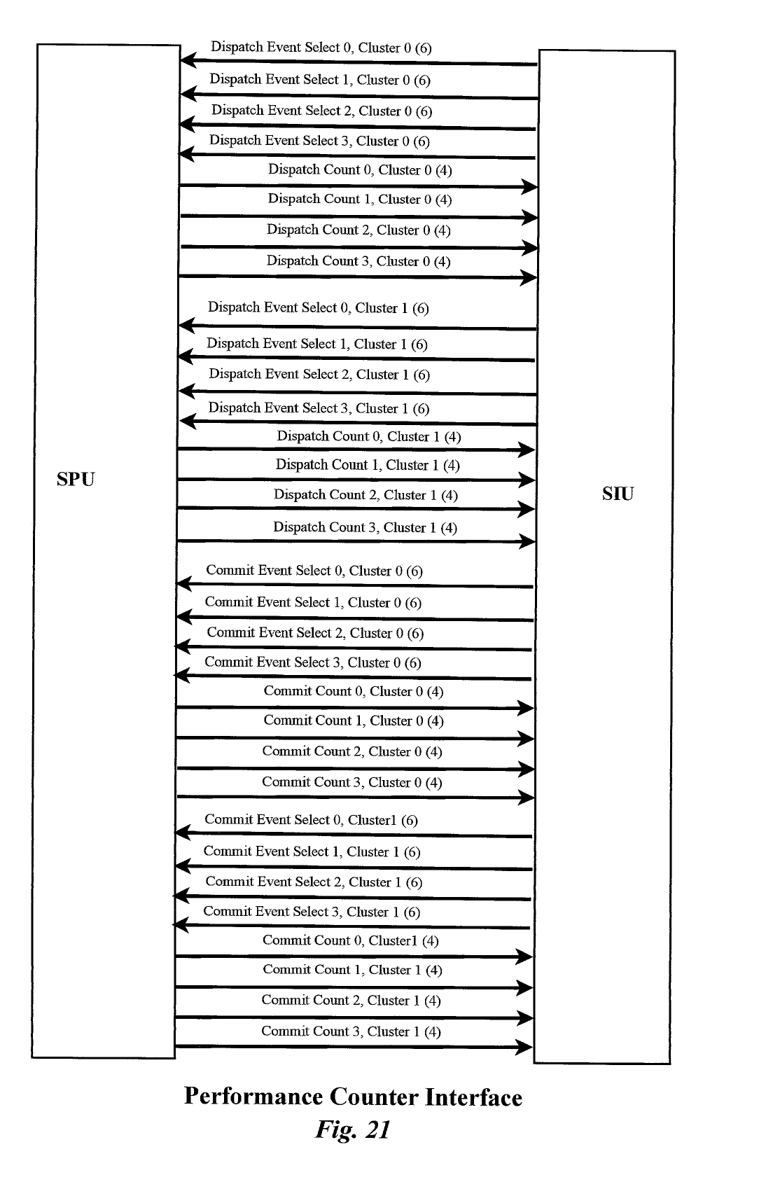

FIG. 21 is an illustration of the performance counter interface between the SPU and the SIU, and provides information as to how performance events are inter-communicated between the SPU and the SIU in the Xcaliber processor.

OCI Interface

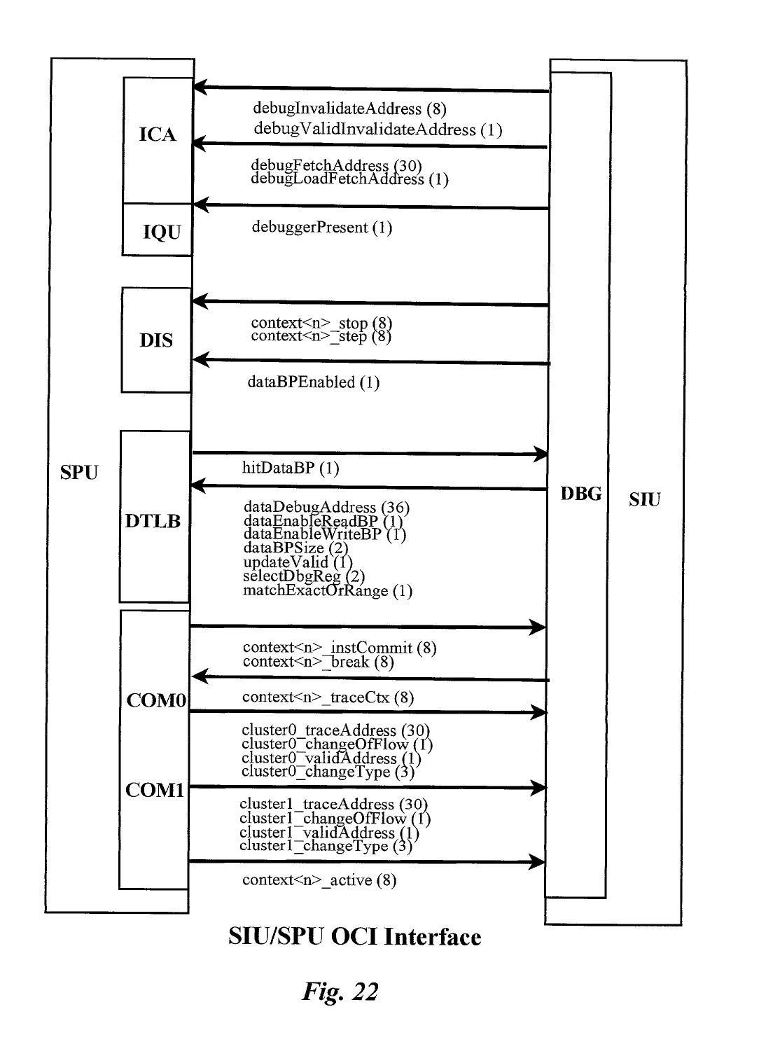

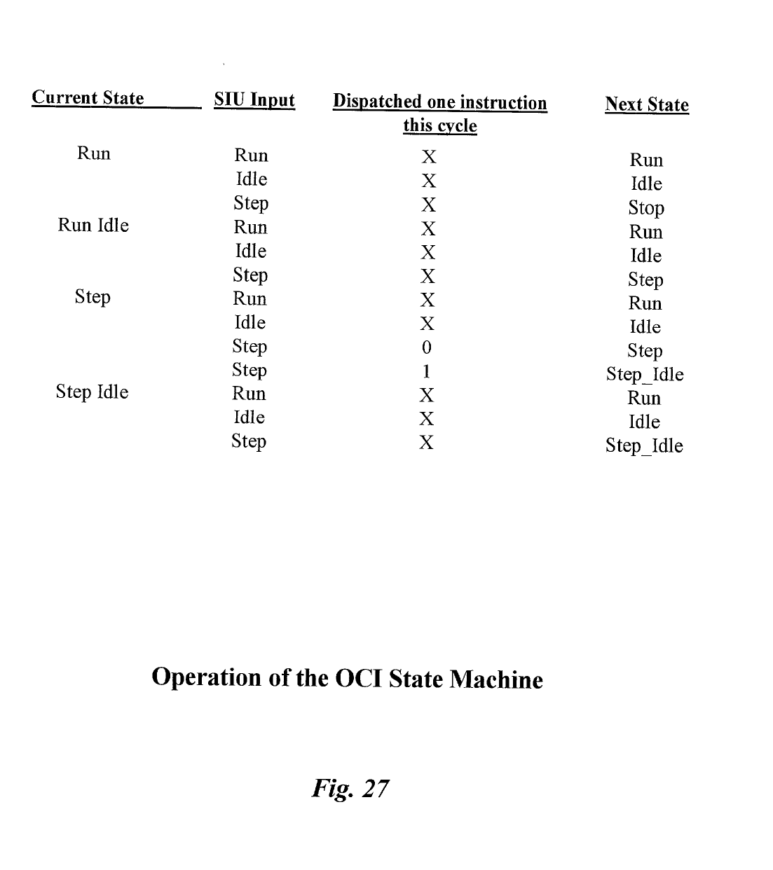

FIG. 22 illustrates the OCI interface between the SIU and the SPU. The detailed behavior of the OCI with respect to the OCI logic and the SPU is illustrated in the Table presented as FIG. 27. This is divided into two parts. The first part is required for implementing the debug features of the OCI. The second part is used for implementing the trace functionality of the OCI.

The dispatch logic has a two bit state machine that controls the advancement of instruction dispatch. The states are listed here as reflected by the SPU specification. The four states are RUN, IDLE, STEP, and STEP_IDLE.

FIG. 27 is a table illustrating operation of this state machine within the dispatch block.

The SIU has two bits (bit 1, STOP and bit 0, STEP) to the SPU and these represent the three inputs that the dispatch uses. The encoding of the bits is—

00—Run

01—Illegal

10—Idle

11—Step

The STOP and STEP bits are per context. This allows each context to be individually stopped and single stepped. When STOP is high, the dispatch will stop execution of instructions from that context. To single step a context STEP will be asserted. The next instruction to be executed will be dispatched. To dispatch again, STEP has to go low and then high again.

For single step operations, the commit logic will signal the SIU when the instruction that was dispatched commits. This interface is 8 bits wide, one bit per context. This indicates that one or more instructions completed this cycle. An exception or interrupt could happen in single step mode and the SIU will let the ISR run in single step mode. When the SIU signals STOP to the SPU, there may be outstanding loads or stores. While the SPU will stop dispatching new instructions, existing instructions including loads and stores are allowed to complete. To indicate the existence of pending loads and stores, the commit will send 16 bits to the SIU, two per context. One indicates that there is a pending load and the other indicates a pending store. This information is sent every cycle. The SIU will not update the OCI status information on a context, till all the pending loads and stores for that context are complete, as indicated by these signals being de-asserted (low). Pending stores are defined to be ones where a write has either missed the cache or is to write-through memory. In cases of cache hits, the store completes and there is no pending operation. In this case the line is dirty and has not been written back. In case of a miss, a read is launched and the store is considered to be pending until the line comes back and is put into the data cache dirty. Write-through is considered to be pending until the SIU returns a complete to the SPU. This means that a 32-Byte write request from the SPU to the SIU will never be a pending store, as this transaction can occur only as a cached dirty write-back. This transaction does not belong to any context.

The SIU also has an interface to the FetchPC block of the SPU to change the flow of instructions. This interface is used to point the instruction stream to read out the contents of all the registers for transfer to the external debugger via the OCI. The SIU will provide a pointer to a memory space within the SIU, from where instructions will be executed to store the registers to the OCI. This address will be static and will be configured before any BREAK is encountered. When the external debugger wishes to resume execution, the SIU will provide to the SPU the address of the next instruction to start execution from. This would be the ERET address. This mechanism is similar to the context activation scheme used to start execution of a new thread. The SIU has the ability to invalidate a cache set in the instruction cache. When the external debugger sets a code breakpoint, the SIU will invalidate the cache set that the instruction belongs to. When the SPU re-fetches the cache line, the SIU will intercept the instruction and replace it with the BREAK instruction. When the SPU executes this instruction, instruction dispatch stops and the new PC is used by the SPU. This is determined by a static signal that the SIU sends to the SPU indicating that an external debugger is present and the SPU treats the BREAK as context activation to the debug program counter. The SPU indicates to the SIU, which context hit that instruction. The SIU has internal storage to accommodate all the contexts executing the BREAK instruction and executing the debug code. When the debugger is ready to start execution back, following the ERET, the SIU will monitor the instruction cache for the fetch of the breakpoint address. Provided the breakpoint is still enabled, the SIU will invalidate the set again, as soon as the virtual address of the instruction line is fetched from the instruction cache. In order for this mechanism to work and to truly allow the setting of breakpoints and repeatedly monitoring them, the SPU has to have a mode where the short branch resolution is disabled. The SPU will have to fetch from the instruction cache for every branch. It is expected that this will be lower performance, but should be adequate in debugging mode. The SIU also guarantees that there is no outstanding cache misses to the cache line that has the breakpoint when it invalidates the set.

Data breakpoints are monitored and detected by the data TLB in the SPU. The SIU only configures the breakpoints and obtains the status. Data accesses are allowed to proceed, and on the address matching a breakpoint condition, the actual update of state is squashed. Hence for a load the register being loaded is not written to. Similarly for a store the cache line being written to is not updated. However the tags will be updated in case of a store to reflect a dirty status. This implies that the cache line will be considered to have dirty data, when it actually does not. When the debugged code continues, the load or store will be allowed to complete and the cache data correctly updated. The SPU maintains four breakpoint registers 0-3. The breakpoint registers can be configured either as exact match registers giving four breakpoints or as range registers giving two ranges. If configured as range registers, the following two ranges are supported −0<=address <=1 and 2<=address <=3. When the SPU hits a data breakpoint, the address of the instruction is presented to the external debugger, which has to calculate the data address by reading the registers and computing the address. It can then probe the address before and after the instruction to see how data was changed. The SPU will allow the instruction to complete when the ERET is encountered following the debug routine. The following interface is used by the SIU to set up the registers—

DebugAddress—36 bits. Actual address or one of the two range addresses

ReadBP—1 bit. Indicating that the breakpoint is to be set for read accesses.

WriteBP—1 bit. Indicating that the breakpoint is to be set for write accesses. Both read and write may be

set simultaneously.

Size—2 bits. Indicates the size of the transfer generating the breakpoint. 00-Word. 01- Half-Word. 10-

Byte. 11—Undefined.

Valid—1 bit. Indicates that this is a valid register update.

DbgReg—2 bits. Selects one of the four registers.

ExactRange—1 bit. Selects exact match or range mode. 0—Exact. 1—Range.

The external debugger can access any data that is in the cache, via a special transaction ID that the SIU generates to the SPU. Transaction ID of 127 indicates a hit write-back operation to the SPU. The data cache controller will cause the write-back to take place, at which time the SIU can read or write the actual memory location. Transaction ID of 126 indicates a hit write-back invalidate operation to the SPU. The cache line will be invalidated after the write-back. Transaction IDs 126 and 127 will be generated only one every other cycle. The SIU will guarantee that there is sufficient queue space to support these IDs. The data TLB will indicate to the SIU that the breakpoint hit was a data breakpoint via the DBPhit signal. Whenever breakpoints are enabled, the dispatch will in a mode, where only one instruction per context is issued per cycle. This mode is triggered via a valid load of the breakpoint registers and the SIU asserting the DBPEnabled signal.

The SPU also generates the status of each of the contexts to the SIU. These are signaled from the commit block to indicate the running or not-running status.

Trace Port

For the trace-port functionality, the SIU indicates to the SPU, which two threads are to be traced. This is an eight-bit interface, one bit per context. Every cycle the SPU will send the following data for each of the two contexts—

Address—30 bits. This is the virtual address of the instruction committed. If multiple instructions are committed, this could be the address of any of them. If a branch or jump is committed (irrespective of if it is taken or not), this is the source address of the branch. If interrupts or exceptions are taken, this will be address of the instruction before the handler executes. In case of context activation, this is the address of the first instruction executed.

Transfer—1 bit. Indicates that the address presented is that due to a change of flow.

Valid—1 bit. This indicates that the address sent to the SIU is that of a valid instruction that committed.

Type—3 bits. This indicates the type of transfer.

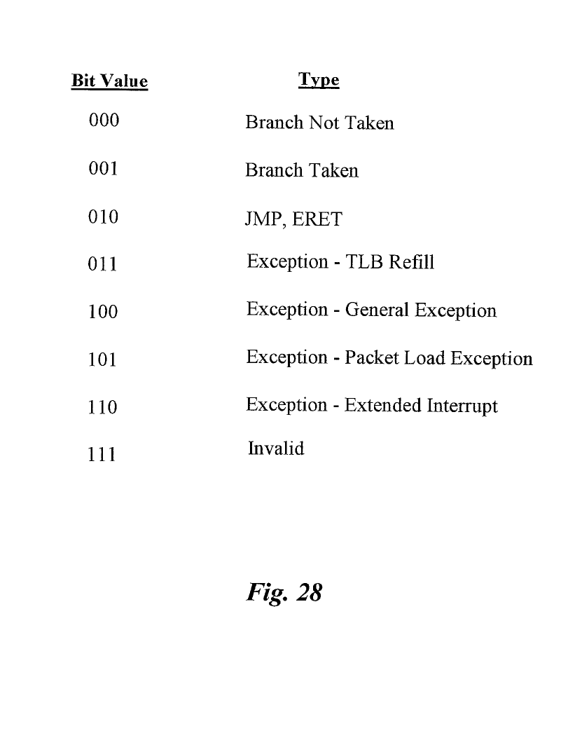

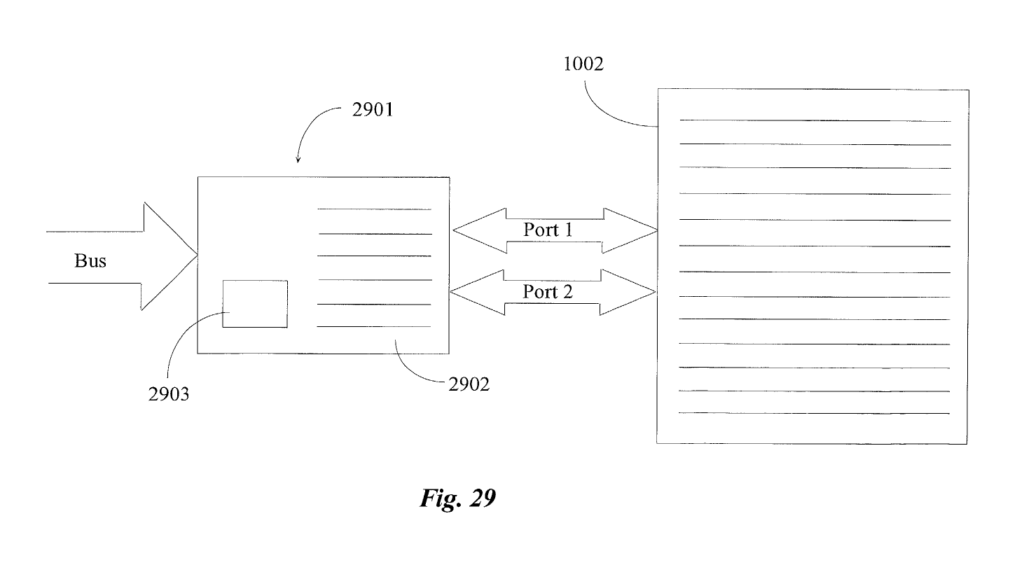

FIG. 28 is a table relating the three type bits to Type.

Summary

It will be apparent to the skilled artisan that the XCaliber processor used as a specific example in the above descriptions is exemplary of the many unique structures and functions having numerous advantages in many ways to the digital processing arts, and that many of the structures and functions may be implemented and accomplished in a variety of equivalent ways to that illustrated in the specific examples give. For these reasons the present invention is to be accorded the breadth of the claims that follow.

What is claimed is:

1. A bypass system for a data cache, comprising:
two ports to the data cache;
registers for multiple data entries;
a bus connection for accepting read and write operations to the cache; and
address matching and switching logic;
characterized in that write operations that hit in the data cache are stored as elements in the bypass structure before the data is written to the data cache, and read operations use the address matching logic to search the elements of the bypass structure to identify and use any one or more of the entries representing data more recent than that stored in the data cache memory array, such that a subsequent write operation may free a memory port for a write stored in the bypass structure to be written to the data cache memory array.

2. The bypass system of claim 1 wherein the memory operations are limited to 32 bits, and there are six distinct entries in the bypass system.

3. A data cache system comprising:
a data cache memory array; and
a bypass system connected to the data cache memory array by two ports, and to a bus for accepting read and write operations to the system, and having address matching and switching logic;
characterized in that write operations that hit in the data cache are stored as elements in the bypass structure before the data is written to the data cache, and read operations use the address matching logic to search the elements of the bypass structure to identify and use any one or more of the entries representing data more recent than that stored in the data cache memory array, such that a subsequent write operation may free a memory port for a write stored in the bypass structure to be written to the data cache memory array.

4. The system of claim 3 wherein the memory operations are limited to 32 bits, and there are six distinct entries in the bypass system.

5. A method for eliminating stalls in read and write operations to a data cache, comprising steps of:
(a) implementing a bypass system having multiple entries and switching and address matching logic, connected to the data cache memory array by two ports and to a bus for accepting read and write operations;
(b) storing write operations that hit in the cache as entries in the bypass structure before associated data is written to the cache;
(c) searching the bypass structure entries by read operations, using the address matching and switching logic to determine if entries in the bypass structure represent newer data than that available in the data cache memory array; and
(d) using the opportunity of a subsequent write operation to free a memory port for simultaneously writing from the bypass structure to the memory array.

6. The method of claim 5 wherein the memory operations are limited to 32 bits, and there are six distinct entries in the bypass system.
